(19) United States
(12) Patent Application Publication
(10) Pub. No.: US 2008/0199217 A1
(43) Pub. Date: Aug. 21, 2008

(54) ELECTROPHOTOGRAPHIC PHOTOCONDUCTOR, ELECTROPHOTOGRAPHIC PROCESS CARTRIDGE INCORPORATING THE SAME, AND IMAGE FORMING APPARATUS INCORPORATING THE SAME

(76) Inventors: Takafumi IWAMOTO, Numazu-shi (JP); Tetsuro Suzuki, Fuji-shi (JP); Hiroshi Tamura, Susono-shi (JP); Hiroshi Ikuno, Yokohama-shi (JP); Hidetoshi Kami, Numazu-shi (JP); Yukio Fujiwara, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/035,016

(22) Filed: Feb. 21, 2008

(30) Foreign Application Priority Data
Feb. 21, 2007 (JP) 2007-040319

(51) Int. Cl. G03G 15/00; G03C 1/73

(52) U.S. Cl. 399/159; 430/58.65

(57) ABSTRACT

An object is to provide an electrophotographic photoconductor which prevents an increase in the friction coefficient of the photoconductor surface caused when printing takes place for a long period of time or in large amounts, which has sustainability of the low photoconductor surface friction coefficient, low wear properties and high durability, and which is particularly superior in polymerized toner (or spherical toner) cleaning capability; a process cartridge incorporating the electrophotographic photoconductor; and an image forming apparatus incorporating the electrophotographic photoconductor. There is an electrophotographic photoconductor including: a photoconductor substrate, a photosensitive layer over the photoconductor substrate, and a protective layer over the photoconductor substrate, wherein the protective layer is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles.

### BACKGROUND OF THE INVENTION

1. Field of the Invention

The present invention relates to an electrophotographic photoconductor used in a copier, electrostatic printing, a printer, electrostatic recording or the like; a process cartridge for an image forming apparatus, using the electrophotographic photoconductor; and an image forming apparatus using the electrophotographic photoconductor.

2. Description of the Related Art

Regarding electrophotographic photoconductors used in image forming apparatuses applied to copiers, laser printers and the like, as opposed to the age when inorganic photoconductors formed of selenium, zinc oxide, cadmium sulfide, etc. were popular, today organic photoconductors (OPCs) are more widely used than inorganic photoconductors because they make it possible to reduce environmental loads, lower costs and enhance design freedom.

These organic photoconductors can be classified according to the layer structure, for example into (1) the homogeneous monolayer type in which a photoconductive resin typified by polyvinylcarbazole (PVK) or a charge transfer complex typified by PVK-TNF (2,4,7-trinitrofluorenone) is provided on a conductive substrate; (2) the dispersion monolayer type in which a resin containing a pigment such as phthalocyanine or perylene in a dispersed manner is provided on a conductive substrate; and (3) the laminated type in which a photosensitive layer provided on a conductive substrate is functionally divided into a charge generating layer (CGL) containing a charge generating material such as azo pigment and a charge transporting layer (CTL) containing a charge transporting material such as triphenylamine.

The laminated type is classified into the construction in which a charge transporting layer is provided on a charge generating layer and, conversely, the construction in which a charge generating layer is provided on a charge transporting layer, with the former being commonly used and the latter being sometimes referred to especially as an inverted layer. Since the laminated type is particularly advantageous in enhancing sensitivity and also high in design freedom with respect to enhancement of sensitivity and durability, most organic photoconductors nowadays employ this layer structure.

As production of things in view of protection of the environment increases in importance today, there is a demand for photoconductors to be shifted from supplied products (disposable products) to mechanical components. To do so, it is necessary to lengthen the lifetime of photoconductors, and provision of protective layers on photosensitive layers is becoming common as an attempt to achieve the lengthening.

Polymerized toner, spherical toner and small-particle-diameter toner (approximately 6 μm or less in particle diameter) that are advantageous in further reducing environmental loads when produced and enhancing image quality are becoming commonly employed as development toners used for electronic photographs. In order to secure capability of cleaning these toners and reuse toners which remain after development, it is hoped that the surfaces of photoconductors will be low in friction coefficient and the low friction coefficient will be sustained even when the photoconductors are repeatedly used.

Meanwhile, capability of cleaning polymerized toner is known to be secured by applying a lubricant such as zinc stearate onto a photoconductor surface and so lowering the friction coefficient of the photoconductor surface (Japan Hardcopy Fall Meeting, 24-27, 2001 by Nobuo Hyakutake, Akihisa Maruyama, Satoshi Shigesaki and Hiroe Okuyama).

However, if a lubricant is externally provided to a photoconductor surface, this lubricant is mixed into toner when the toner is recycled, thereby leading to a change in the quality of the toner. Moreover, since a lubricant applying unit is required, an apparatus is enlarged.

As another means, there is proposed a means of adding a lubricant such as a silicone compound, fluorine resin fine particles or fatty acid ester into an outermost layer of a photoconductor. In particular, there is proposed a means of adding fluorine resin fine particles into an outermost layer of a photoconductor for securing capability of cleaning polymerized toner (as in Japanese Patent Application Laid-Open (JP-A) Nos. 11-218953 and 11-272003).

Inclusion of fluorine resin fine particles is an effective means of lowering the friction coefficient of a photoconductor surface; however, use of this means alone involves increasing the friction coefficient of the photoconductor surface through repetitive or long-term use and making it difficult to sustain an initial low surface friction coefficient. In this case, the friction coefficient of the photoconductor surface increases immediately after use. Also, a coating film becomes very uneven in thickness, thereby causing toner to leak. As a result of the insufficient cleaning capability, replacement of the photoconductor is necessitated.

In order to lower the friction coefficient of the photoconductor surface, it is necessary for the fluorine resin fine particles to be contained with a higher concentration than is predetermined; in this case, however, the film becomes brittle as described in Paragraph No. [0013] of JP-A No. 07-13381 and in Paragraph No. [0026] of JP-A No. 10-142816. Also, even when the fluorine resin fine particles are prepared so as to be contained by the amount prescribed in these publications, the abrasion resistance of the photoconductor deteriorates in many cases owing to the fact that the fluorine resin fine particles are contained.

Reduction in the amount of the fluorine resin fine particles entails increasing the friction coefficient of the photoconductor surface, and the cleaning capability becomes insufficient, thereby causing the photoconductor surface to be polluted.

There is proposed a means of adding a fluorine atom-containing polymer into a protective layer (as in JP-A No. 2006-99099). This method makes it possible to reduce surface free energy but does not make it possible to lower the friction coefficient of a photoconductor surface, so that there is greater film peeling, and a long lifetime is difficult to achieve.

As a means of keeping in the most suitable range the amount of fluorine resin fine particles contained in a photoconductor surface, there is proposed a method of mixing together a polycarbonate resin having a skeleton of bisphenol A, a fluorine-based graft polymer and fluorine resin fine particles (Japanese Patent (JP-B) No. 3028270).

Polycarbonate resins generally have great surface free energy, thereby easily causing attachment (filming) of foreign materials such as toner to the surfaces thereof. Also, polycarbonate resins have great peeling resistance and their abrasion resistance is limited, thus making it impossible to achieve a long lifetime.

It is possible to assert that sustainability of both high abrasion resistance and low wear properties of surfaces is hoped for as a present-day requirement for electrophotographic photoconductors. It goes without saying that high sensitivity and stable properties able to withstand environmental changes are also required. However, a means for satisfying the foregoing has not yet been found.

### BRIEF SUMMARY OF THE INVENTION

An object of the present invention is to provide an electrophotographic photoconductor which prevents an increase in the friction coefficient of the photoconductor surface caused when printing takes place for a long period of time or in large amounts, which has sustainability of the low photoconductor surface friction coefficient, low wear properties and high durability, and which is particularly superior in polymerized toner (or spherical toner) cleaning capability; a process cartridge incorporating the electrophotographic photoconductor; and an image forming apparatus incorporating the electrophotographic photoconductor.

As a result of carrying out a series of earnest examinations, the present inventors have found that the object can be achieved by employing an electrophotographic photoconductor including at least on its surface a protective layer which is formed by curing together a trifunctional or more radical polymerizable monomer having no charge transporting structure, a fluorine-based UV-curable hard coat agent and a monofunctional radical polymerizable compound having a charge transporting structure and which contains lubricant fine particles, thereby presenting the present invention.

Specifically, by satisfying the following constituent requirements, it is possible to provide an electrophotographic photoconductor which is superior in cleaning capability, remarkable for its sustainability of low surface energy and a low friction coefficient, high and stable in abrasion resistance, excellent in electrical properties and especially suitable for a polymerized toner (or spherical toner) and which achieves enhancement of image quality for a long period of time; also, it is possible to provide an image forming apparatus, and a process cartridge for an image forming apparatus, each of which uses such a long-life, high-performance photoconductor.

The object of the present invention is achieved by means of (1) to (8) below.
(1) An electrophotographic photoconductor including: a photoconductor substrate, a photosensitive layer on the photoconductor substrate, and a protective layer on the photoconductor substrate, wherein the protective layer is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles.
(2) The electrophotographic photoconductor according to (1), wherein the lubricant fine particles contain one or more selected from fluorine resin fine particles, a silicone compound and polyethylene wax.
(3) The electrophotographic photoconductor according to any one of (1) and (2), wherein the fluorine-based UV-curable hard coat agent has a urethane bond in its molecule.
(4) The electrophotographic photoconductor according to any one of (1) to (3), wherein the content of the fluorine-based UV-curable hard coat agent and the lubricant fine particles in the protective layer is equal to or greater than 5% by mass and less than 60% by mass with respect to the total weight of the protective layer, and the fluorine-based UV-curable hard coat agent and the lubricant fine particles are mixed together with a mass ratio of 3:7 to 7:3.
(5) The electrophotographic photoconductor according to any one of (1) to (4), wherein the monofunctional radical polymerizable compound having a charge transporting structure is represented by the following structural formula.

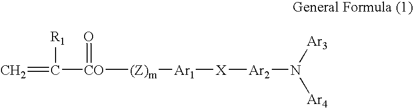

where R₁ denotes a hydrogen atom, a halogen atom, an alkyl group that may have a substituent, an aralkyl group that may have a substituent, an aryl group that may have a substituent, a cyano group, a nitro group, an alkoxy group, a —COOR₇ group (R₇ denotes a hydrogen atom, an alkyl group that may have a substituent, an aralkyl group that may have a substituent, or an aryl group that may have a substituent), a carbonyl halide group or a —CONR₈R₉ group (R₈ and R₉ each denote a hydrogen atom, a halogen atom, an alkyl group that may have a substituent, an aralkyl group that may have a substituent, or an aryl group that may have a substituent, and they may be identical or different from each other); Ar₁ and Ar₂ each denote a substituted or unsubstituted arylene group, and they may be identical or different from each other; Ar₃ and Ar₄ each denote a substituted or unsubstituted aryl group, and they may be identical or different from each other; X denotes a single bond, a substituted or unsubstituted alkylene group, a substituted or unsubstituted cycloalkylene group, a substituted or unsubstituted alkylene ether group, an oxygen atom, a sulfur atom or a vinylene group; Z denotes a substituted or unsubstituted alkylene group, a substituted or unsubstituted alkylene ether divalent group, or an alkyleneoxycarbonyl divalent group; and “m” denotes an integer of 0 to 3.
(6) The electrophotographic photoconductor according to any one of (1) to (5), wherein the components of the protective layer are cured by any one of heating and irradiation with light energy.
(7) A process cartridge for an image forming apparatus, including: the electrophotographic photoconductor according to any one of (1) to (6), and one or more selected from the group consisting of a charging unit, a developing unit, a transfer unit, a cleaning unit and a charge-eliminating unit, wherein the process cartridge is detachably mountable to the image forming apparatus main body.
(8) An image forming apparatus including the electrophotographic photoconductor according to any one of (1) to (6) or the process cartridge according to (7).

The electrophotographic photoconductor, the electrophotographic process cartridge and the image forming apparatus of the present invention prevent an increase in the friction coefficient of the photoconductor surface caused when printing takes place for a long period of time or in large amounts, have both sustainability of the low photoconductor surface friction coefficient and low wear properties, and are superior in abrasion resistance and therefore highly durable. Thus, they are capable of forestalling failure to clean off toner and reducing the number of times photoconductors are replaced, and are therefore superior in practical value. Also, not needing to incorporate an external unit for supplying lubricant to the photoconductor, the image forming apparatus is designed to be an environment-friendly image forming apparatus that makes it easier for toners to be recycled.

### BRIEF DESCRIPTION OF THE SEVERAL VIEWS OF THE DRAWINGS

FIG. 1 is a schematic cross-sectional view showing an example of an image forming apparatus according to the present invention.

FIG. 2 is a schematic cross-sectional view showing another example of an image forming apparatus according to the present invention.

FIG. 3 is a schematic cross-sectional view showing an example of a process cartridge according to the present invention.

FIG. 4 is a schematic cross-sectional view showing yet another example of an image forming apparatus according to the present invention.

FIG. 5 is a schematic cross-sectional view showing still another example of an image forming apparatus according to the present invention.

FIG. 6 is a schematic cross-sectional view showing still yet another example of an image forming apparatus according to the present invention.

FIG. 7 is a cross-sectional view showing a layer structure of an electrophotographic photoconductor according to the present invention.

FIG. 8 is a figure showing the position in which a leaking toner catcher is installed when the leakage intensity is measured.

### DETAILED DESCRIPTION OF THE INVENTION

The following explains the present invention in detail.

The present invention is characterized in that a protective layer of a photoconductor is formed by curing together at least a trifunctional or more radical polymerizable monomer having no charge transporting structure, a fluorine-based UV-curable hard coat agent and a monofunctional radical polymerizable compound having a charge transporting structure, and that the protective layer contains lubricant fine particles.

An electrophotographic photoconductor is used in such an environment that a series of processes including charging, developing, transfer, cleaning and charge elimination is repeated, and since the photoconductor wears or is scratched as it is used in this manner, images are caused to deteriorate and thus the photoconductor finishes being used. The photoconductor wears or is scratched, mainly due to (1) decomposition of a photoconductor surface composition caused by electric discharge and chemical deterioration caused by oxidized gas at the times of charging and charge elimination; (2) attachment of carriers at the time of developing; (3) friction between the photoconductor and paper at the time of transfer; (4) friction between the photoconductor and a cleaning brush, a cleaning blade or toner/attached carriers interposed, at the time of cleaning; and so forth.

In order to design a photoconductor which is strong enough to resist such hazards, it is important to make a protective layer very hard, highly elastic and uniform, and a process of forming an intricate, homogeneous three-dimensional network structure as a film structure is promising. For example, in a protective layer with a crosslinked structure formed by curing a trifunctional or more radical polymerizable monomer and a monofunctional radical polymerizable compound having a charge transporting structure, a three-dimensional network structure is developed, so that a very hard, highly elastic protective layer with a very high crosslink density can be obtained, and high abrasion resistance and high scratch resistance can be achieved. Accordingly, the problem (1) can be coped with.

It is possible to cope with the problem (2) by making the protective layer include a fluorine atom-containing polymer and so reducing the free energy of the photoconductor surface. However, the problems (3) and (4) remain unsolved.

It is possible to cope with the problems (3) and (4) by making the protective layer include lubricant fine particles and so lowering the friction coefficient of the photoconductor surface. However, the foregoing means entails increasing the friction coefficient of the photoconductor surface through repetitive or long-term use, and it is therefore difficult to sustain an initial low surface friction coefficient. In this case, the friction coefficient of the photoconductor surface increases, immediately after the photoconductor starts being used. Also, a coating film becomes very uneven in thickness, thereby causing toner to leak. As a result of the insufficient cleaning capability, replacement of the photoconductor is necessary. In order to lower the friction coefficient of the photoconductor surface, it is necessary for the lubricant fine particles to be contained with a higher concentration than is predetermined; in this case, however, the film becomes brittle as described in JP-A No. 07-13381, Paragraph No. [0013] and JP-A No. 10-142816, Paragraph No. [0026]. Also, even when the lubricant fine particles are prepared so as to be contained by the amount prescribed in these publications, the abrasion resistance of the photoconductor deteriorates in many cases owing to the fact that the lubricant fine particles are contained. Reduction in the amount of the lubricant fine particles entails increasing the friction coefficient of the photoconductor surface, and the cleaning capability becomes insufficient, thereby causing the photoconductor surface to be polluted.

These troubles can be avoided by providing an electrophotographic photoconductor including a protective layer which is formed by curing together at least a trifunctional or more radical polymerizable monomer having no charge transporting structure, a fluorine-based UV-curable hard coat agent and a monofunctional radical polymerizable compound having a charge transporting structure, and which contains lubricant fine particles. The content of the fluorine-based UV-curable hard coat agent and the lubricant component in the protective layer is preferably equal to or greater than 5% by mass and less than 60% by mass with respect to the solid content weight of the protective layer, and the fluorine-based UV-curable hard coat agent and the lubricant fine particles are mixed together preferably with a mass ratio of 3:7 to 7:3. When the content of the fluorine-based UV-curable hard coat agent and the lubricant component in the protective layer is less than 5%, cleaning effects cannot be sufficiently produced. When the content of the fluorine-based UV-curable hard coat agent and the lubricant component in the protective layer is 60% or greater, sufficient film strength may not be obtained. When the fluorine-based UV-curable hard coat agent and the lubricant fine particles are mixed together with a mass ratio of 3:7 to 7:3, both the effect of reducing the friction coefficient of the photoconductor surface and the effect of reducing the free energy thereof can be sufficiently produced for uncertain reasons.

As a means of lowering the friction coefficient of the photoconductor surface, inclusion of a lubricant in the outermost surface layer of the photoconductor is effective. Needing to secure smoothness of the photoconductor surface, the lubricant is preferably a liquid lubricant, or a solid lubricant which is small in particle diameter and able to be evenly dispersed. Examples of the materials which can satisfy the foregoing include lubricant fine particles such as silicone compounds, fluorine resin fine particles and polyethylene wax.

When a fluorine-based UV-curable hard coat agent having no urethane bond in its molecule is used in the protective layer, the residual potential and the post-exposure potential may possibly increase and the photoconductor sensitivity may possibly decrease. Accordingly, by using in the protective layer a fluorine-based UV-curable hard coat agent having a urethane bond in its molecule, it is possible to produce a photoconductor which does not cause the problems.

Since the monofunctional radical polymerizable compound having a charge transporting structure, represented by General Formula (1), in the present invention is polymerized with double bonds between carbon atoms being open at both sides, it does not become a terminate structure and it is incorporated into a chain polymer; in a polymer formed by crosslinking polymerization between the monofunctional radical polymerizable compound and a trifunctional or more radical polymerizable monomer, the monofunctional radical polymerizable compound is present in a high-molecular main chain and also in a crosslinked chain between main chains (the crosslinked chain is classified into an intermolecular crosslinked chain formed between one polymer and another, and an intramolecular crosslinked chain in which a site where there is a folded main chain and a monomer-derived site polymerized in a position away from the foregoing site in the main chain are crosslinked in one polymer); whether the monofunctional radical polymerizable compound is present in the main chain or in the crosslinked chain, the triarylamine structures hanging down from chain parts have at least three aryl groups each, which are disposed in radial directions from a nitrogen atom; although bulky, it is not that the triarylamine structures are directly bonded to the chain parts but that they are hanging down from the chain parts via carbonyl groups or the like, so that they are fixed in such a manner as to allow for flexible steric positioning and thus these triarylamine structures can be spatially positioned so as to be suitably adjacent to each other in the polymer; therefore, there is little structural strain in molecules; also, when the monofunctional radical polymerizable compound is used for a protective layer of an electrophotographic photoconductor, it is inferred that an intramolecular structure which is relatively free of severance of a charge transporting path can be employed.

In the present invention, a protective layer is formed by applying such a protective layer coating solution and then curing it with application of energy from outside; the external energy used on this occasion is selected from thermal energy, light energy and radiant energy. As to how the thermal energy is applied, the protective layer coating solution is heated from the coated surface side or the substrate side, using a gas such as air or nitrogen, vapor, any type of heating medium, an infrared ray or an electromagnetic wave. It is desirable that the heating temperature be in the range of 100° C. to 170° C.; when it is less than 100° C., the reaction velocity is low, and the curing reaction does not completely finish. When it is greater than 170° C., the curing reaction progresses unevenly, and great strain or a large number of unreacted residues and unreactive termini arise in the protective layer. To make the curing reaction progress evenly, there is an effective method in which after the protective layer coating solution is heated at a relatively low temperature of less than 100° C., it is heated at 100° C. or greater and the reaction is thus completed. For the light energy, a UV irradiation light source such as a high-pressure mercury-vapor lamp or metal halide lamp having an emission wavelength in the ultraviolet region is mainly used; it is also possible to opt for a visible light source according to the absorption wavelength of a radical polymerizable contained material or a photopolymerization initiator. It is desirable that the dose of light irradiation be in the range of 50 mW/cm² to 1,000 mW/cm²; when it is less than 50 mW/cm², the curing reaction takes a great deal of time. When it is greater than 1,000 mW/cm², the reaction progresses unevenly, and local creases arise on the protective layer surface, or a large number of unreacted residues and unreactive termini arise. Also, the abrupt crosslinkage makes internal stress greater, which is a cause of cracks and film peeling. Examples of the radiant energy include energy by means of electron rays. Amongst these forms of energy, thermal energy and light energy are useful in that the reaction velocity can be controlled with ease and an apparatus can be simplified. Note that although the protective layer coating solution is cured by being heated, it is not sufficiently cured because of the fluorine-based UV-curable hard coat agent and so the desired properties (abrasion resistance) may not be performed; therefore, preference is given to light energy and further preference is given to UV irradiation.

Next, constituent materials for the protective layer coating solution of the present invention will be explained.

The trifunctional or more radical polymerizable monomer having no charge transporting structure in the present invention denotes a monomer which has neither a hole transport structure such as triarylamine, hydrazone, pyrazoline, carbazole, etc. nor an electron transport structure such as condensed polycyclic quinone, diphenoquinone, an electron-withdrawing aromatic ring having a cyano group or nitro group, etc., and which has three or more radical polymerizable functional groups. For these radical polymerizable functional groups, any groups are suitable as long as they have carbon-carbon double bonds and are capable of radical polymerization.

Examples of these radical polymerizable functional groups include the 1-substituted ethylene functional groups and the 1,1-substituted ethylene functional groups shown below.
(1) Examples of the 1-substituted ethylene functional groups include the functional groups represented by the following formula.

CH₂═CH—X₁— Formula 10

where X₁ denotes an arylene group, such as phenylene group or naphthylene group, that may have a substituent; an alkenylene group that may have a substituent; a —CO— group; a —COO— group; a —CON(R₁₀)— group (R₁₀ denotes a hydrogen atom, an alkyl group such as methyl group or ethyl group, an aralkyl group such as benzyl group, naphthylmethyl group or phenethyl group, or an aryl group such as phenyl group or naphthyl group); or a —S— group.

Specific examples of these substituents include vinyl group, styryl group, 2-methyl-1,3-butadienyl group, vinylcarbonyl group, acryloyloxy group, acryloylamide group and vinyl thioether group. (2) Examples of the 1,1-substituted ethylene functional groups include the functional groups represented by the following formula.

CH₂═C(Y)—X₂— Formula 11

where Y denotes an alkyl group that may have a substituent; an aralkyl group that may have a substituent; an aryl group, such as phenyl group or naphthyl group, that may have a substituent; a halogen atom; a cyano group; a nitro group; an alkoxy group such as methoxy group or ethoxy group; a —COOR₁₁ group (R₁₁ denotes a hydrogen atom; an alkyl group, such as methyl group or ethyl group, that may have a substituent; an aralkyl group, such as benzyl group or phenethyl group, that may have a substituent; or an aryl group, such as phenyl group or naphthyl group, that may have a substituent); or a −CONR₁₂R₁₃ group (R₁₂ and R₁₃ each denote a hydrogen atom; an alkyl group, such as methyl group or ethyl group, that may have a substituent; an aralkyl group, such as benzyl group, naphthylmethyl group or phenethyl group, that may have a substituent; or an aryl group, such as phenyl group or naphthyl group, that may have a substituent; and they may be identical or different from each other.); meanwhile, X₂ denotes the same substituent, single bond or alkylene group as X₁ in Formula 10 above. Here, note that at least either Y or X₂ denotes an oxycarbonyl group, a cyano group, an alkenylene group or an aromatic ring.

Specific examples of these substituents include α-acryloyloxy chloride group, methacryloyloxy group, α-cyanoethylene group, α-cyanoacryloyloxy group, α-cyano phenylene group and methacryloyl amino group.

Examples of substituents replacing these substituents for X₁, X₂ and Y include halogen atom, nitro group, cyano group, alkyl groups such as methyl group and ethyl group, alkoxy groups such as methoxy group and ethoxy group, aryloxy groups such as phenoxy group, aryl groups such as phenyl group and naphthyl group, and aralkyl groups such as benzyl group and phenethyl group.

Amongst these radical polymerizable functional groups, acryloyloxy group and methacryloyloxy group are particularly useful, and a compound having three or more acryloyloxy groups can be obtained, for example by using a compound having three or more hydroxyl groups in a molecule thereof and acrylic acid (salt), acrylic acid halide or acrylic acid ester, and bringing them into ester reaction or ester exchange reaction. Also, a compound having three or more methacryloyloxy groups can be obtained in a similar manner. Radical polymerizable functional groups in a monomer having three or more radical polymerizable functional groups may be identical or different from each other.

Specific examples of the trifunctional or more radical polymerizable monomer having no charge transporting structure include, but not limited to, the following compounds.

The specific examples of the radical polymerizable monomer in the present invention include trimethylolpropane triacrylate (TMPTA), trimethylolpropane trimethacrylate, trimethylolpropane alkylene-modified triacrylate, trimethylolpropane ethyleneoxy-modified (hereinafter referred to as “EO-modified”) triacrylate, trimethylolpropane propyleneoxy-modified (hereinafter referred to as “PO-modified”) triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified (hereinafter referred to as “ECH-modified”) triacrylate, glycerol EO-modified triacrylate, glycerol PO-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol pentaacrylate, alkylated dipentaerythritol tetraacrylate, alkylated dipentaerythritol triacrylate, dimethylolpropane tetraacrylate (DTMPTA), pentaerythritolethoxy tetraacrylate, phosphoric acid EO-modified triacrylate and 2,2,5,5,-tetrahydroxymethylcyclopentanone tetraacrylate. These can be used independently or in combination.

The proportion of the content of the trifunctional or more radical polymerizable monomer having no charge transporting structure, used for the protective layer is 20% by mass to 80% by mass, preferably 30% by mass to 70% by mass, to the total weight of the protective layer, and this proportion substantially depends upon the proportion of a trifunctional or more radical polymerizable reactive monomer in the solid content of the coating solution. When the monomer component is less than 20% by mass, the three-dimensional crosslinking bond density of the protective layer is small, and a dramatic improvement in abrasion resistance becomes less achievable than in the case where a conventional thermoplastic binder resin is used. When the monomer component is greater than 80% by mass, the content of a charge transporting compound decreases, and there is a deterioration in electrical properties. Required electrical properties and abrasion resistance vary according to the process used, thereby also causing the protective layer of the photoconductor to vary in thickness, and it is therefore impossible to state the range of the proportion of the content unequivocally; nevertheless, the range of 30% by mass to 70% by mass is most desirable in view of a balance between electrical properties and abrasion resistance.

The fluorine-based UV-curable hard coat agent in the present invention denotes a compound which has neither a hole transport structure such as triarylamine, hydrazone, pyrazoline, carbazole, etc. nor an electron transport structure such as condensed polycyclic quinone, diphenoquinone, an electron-withdrawing aromatic ring having a cyano group or nitro group, etc., and which has a fluoroalkyl group and one radical polymerizable functional group. For this radical polymerizable functional group, any group is suitable as long as it has a carbon-carbon double bond and is capable of radical polymerization.

The fluorine-based UV-curable hard coat agent can be obtained by making a fluorine-based hard coat agent react with a curing auxiliary for UV curing. In the present invention, the fluorine-based hard coat agent is supposed to be cured by light or heat, and so the trifunctional or more radical polymerizable monomer and the monofunctional radical polymerizable compound cannot be sufficiently cured by means of UV curing if this is used alone. Accordingly, the curing auxiliary for UV curing is additionally used to yield the fluorine-based UV-curable hard coat agent. Regarding the protective layer according to the present invention, when it is formed, the fluorine-based hard coat agent and the curing auxiliary may be added as the fluorine-based UV-curable hard coat agent into the protective layer coating solution and cured along with the trifunctional or more radical polymerizable monomer having no charge transporting structure and the monofunctional radical polymerizable compound having a charge transporting structure.

Examples of the fluorine-based hard coat agent include, but not limited to, the following compounds.

As the examples, commercially-supplied products for the fluorine-based hard coat agent in the present invention are shown below.

CEFRAL COAT (Central Glass Co., Ltd.), DEFENSER (Dainippon Ink And Chemicals, Incorporated) (which is a compound formed by subjecting an alkyl group tetrafluoride to graft polymerization), MODIPER F,FS (NOF Corporation) (which is a block copolymer of polymethacrylic acid ester and polyacrylic acid alkyl fluoride) and the like are suitable, and these may be used independently or in combination.

For the fluorine-based UV-curable hard coat agent, a compound having a urethane bond in its molecule is suitable. Therefore, a radical polymerizable isocyanate monomer can be suitably used as the curing agent. Suitable examples of the radical polymerizable isocyanate monomer include KARENZ MOI, KARENZ MOI-BM, KARENZ MO-BP, KARENZ AOI and KARENZ BEI (Showa Denko K.K.). Each of these has in its molecule an isocyanate group and a UV-curable carbon-carbon double bond.

The ratio of the amount of the radical polymerizable isocyanate monomer to that of the fluorine-based hard coat agent is preferably 0.9:1 to 1.1:1. When the amount of the radical polymerizable isocyanate monomer is too small, curing does not take place sufficiently, and when it is too large, there is a rise in residual potential.

The lubricant fine particles in the present invention are formed of fluorine resin fine particles, a silicone compound, polyethylene wax, etc. and added to the protective layer for the purpose of lowering the friction coefficient.

Examples of the raw material for the fluorine resin fine particles used in the protective layer include polytetrafluoroethylene (PTFE), tetrafluoroethylene/perfluoroalkyl vinyl ether copolymer (PFA), tetrafluoroethylene/hexafluoropropylene copolymer (FEP), tetrafluoroethylene/hexafluoropropylene/perfluoroalkyl vinyl ether copolymer (EPE), tetrafluoroethylene/ethylene copolymer (ETFE), polychlorotrifluoroethylene (PCTFE), chlorotrifluoroethylene/ethylene copolymer (ECTFE), polyvinylidene fluoride (PVDF) and polyvinyl fluoride (PVF). Amongst these, polytetrafluoroethylene (PTFE), tetrafluoroethylene/perfluoroalkyl vinyl ether copolymer (PFA) and tetrafluoroethylene/hexafluoropropylene copolymer (FEP) are preferable in the present invention in that the friction coefficient of the photoconductor surface can be lowered and the ductility of the fluorine resins themselves is relatively high.

As the silicone compound, an acrylic-silicone copolymer can also be used effectively in the present invention. As the acrylic-silicone copolymer, it is advisable to use a product such as CHALINE R-170 or CHALINE R-170S put on the market by Nissin Chemical Industry Co., Ltd. These are 0.2 μm in primary particle diameter and can therefore be used without being pretreated.

For the polyethylene wax, HI-WAX 100P produced by Mitsui Chemicals, Inc. or CERAFLOUR 991 produced by BYK-Cera is suitable.

The fluorine resin fine particles, the silicone compound and the polyethylene wax can be pulverized (ground) and dispersed similarly to one another, by means of a ball mill, vibration mill, sand mill or the like.

It is possible to surface-treat the lubricant fine particles in the present invention by at least one type of dispersant/surfactant. The foregoing is favorable in terms of dispersibility, especially when the lubricant fine particles are small in diameter. A decrease in the dispersibility of the lubricant fine particles causes not only a rise in residual potential but also a decrease in the transparency of a coating film, a defect in the coating film and a decrease in abrasion resistance, thereby possibly hindering achievement of high durability or high image quality, which is a serious problem. For the dispersant/surfactant, a conventional dispersant/surfactant can be used, with a dispersant/surfactant capable of maintaining the insulating properties of the lubricant fine particles being preferable.

Although the amount of surface treatment varies according to the average primary particle diameter of the lubricant fine particles used, it is appropriate that the amount of surface treatment be 3% by mass to 30% by mass to the weight of the lubricant fine particles, more preferably 5% by mass to 20% by mass. When the amount of the dispersant/surfactant is smaller than this, dispersing effects of a filler cannot be obtained, and when the amount thereof is far larger than this, a sharp rise in residual potential is caused. Such surface-treating agents are used independently or in combination.

In the present invention, the low friction properties of the photoconductor surface can be favorably sustained when the lubricant fine particles additionally used are in the range of 0.05 μm to 1 μm in primary particle diameter. Although details of the foregoing remain unclear, it is inferred that the fine particles which have appeared over the photoconductor surface are expanded to cover the whole photoconductor surface by a member that slides over the photoconductor, such as a cleaning blade. Meanwhile, it is inferred that lubricant fine particles of less than 0.05 μm in diameter will be swept to the outside of the photoconductor system along with abrasion powder. Thus, desired effects are deemed difficult to realize. Materials which are large in particle diameter vary in their sustainability of the low friction properties and are therefore unstable. To gain sustainability of the low friction properties by the inclusion of lubricant fine particles, it is appropriate that the lubricant fine particles be in the range of 0.05 μm to 1 μm in primary particle diameter.

The content of the fluorine-based UV-curable hard coat agent and the lubricant fine particles in the protective layer is preferably equal to or greater than 5% by mass and less than 60% by mass with respect to the total weight of the protective layer, and the fluorine-based UV-curable hard coat agent and the lubricant fine particles are mixed together preferably with a mass ratio of 3:7 to 7:3.

Two or more types of fluorine-based UV-curable hard coat agents may be mixed together. The content of the fluorine-based UV-curable hard coat agent is preferably 2% by mass to 30% by mass, more preferably 5% by mass to 20% by mass, to the solid content of the coating solution forming a crosslinked surface layer. When the content of the fluorine-based UV-curable hard coat agent is less than 2% by mass, the proportion of fluorine in the crosslinked surface layer is too small to realize surface energy which is sufficiently low, and thus favorable cleaning capability may not be exhibited. When it is greater than 30% by mass, it is difficult to obtain a coating film that is homogeneous and has a smooth surface, which is disadvantageous.

In the present invention, the low surface energy is effected due to the necessity to sustain the low friction properties of the photoconductor surface; accordingly, it is desirable that the ratio of the lubricant fine particles included be 3% by mass or greater to the total weight of the solid content of a crosslinked resinous surface layer. To sustain the low friction coefficient of the photoconductor surface by its own durability, without depending upon the characteristics of an electrophotographic device, it is more desirable that the ratio of the lubricant fine particles included be approximately 10% by mass to the total weight of the surface layer. Meanwhile, when the ratio of the lubricant fine particles included exceeds 30% by mass, in effect, it becomes difficult to obtain further improvement in the low friction coefficient sustainability of the photoconductor surface by increasing the ratio, and it becomes difficult to form a smooth photoconductor surface in depositing the protective layer according to a wet coating method; hence, it is advisable to make the ratio equal to or lower than 30% by mass.

The monofunctional radical polymerizable compound having a charge transporting structure in the protective layer of the present invention denotes a compound which has a hole transport structure such as triarylamine, hydrazone, pyrazoline, carbazole, etc. and an electron transport structure such as condensed polycyclic quinone, diphenoquinone, an electron-withdrawing aromatic ring having a cyano group or nitro group, etc., and which has one radical polymerizable functional group. This radical polymerizable functional group is exemplified by the functional groups represented by Formulae 10 and 11. More specific examples thereof include the functional groups mentioned for the radical polymerizable monomer; amongst them, acryloyloxy group and methacryloyloxy group are particularly useful. As a charge transporting structure, a triarylamine structure is highly effective; in particular, when the compound represented by General Formula (1) below is used, electrical properties such as sensitivity and residual potential can be favorably sustained.

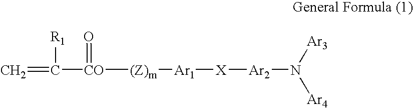

where R₁ denotes a hydrogen atom, a halogen atom, an alkyl group that may have a substituent, an aralkyl group that may have a substituent, an aryl group that may have a substituent, a cyano group, a nitro group, an alkoxy group, a —COOR₇ group (R₇ denotes a hydrogen atom, an alkyl group that may have a substituent, an aralkyl group that may have a substituent, or an aryl group that may have a substituent), a carbonyl halide group or a —CONR₈R₉ group (R₈ and R₉ each denote a hydrogen atom, a halogen atom, an alkyl group that may have a substituent, an aralkyl group that may have a substituent, or an aryl group that may have a substituent, and they may be identical or different from each other); Ar₁ and Ar₂ each denote a substituted or unsubstituted arylene group, and they may be identical or different from each other. Ar₃ and Ar₄ each denote a substituted or unsubstituted aryl group, and they may be identical or different from each other. X denotes a single bond, a substituted or unsubstituted alkylene group, a substituted or unsubstituted cycloalkylene group, a substituted or unsubstituted alkylene ether group, an oxygen atom, a sulfur atom or a vinylene group. Z denotes a substituted or unsubstituted alkylene group, a substituted or unsubstituted alkylene ether divalent group, or an alkyleneoxycarbonyl divalent group. “m” and “n” each denote an integer of 0 to 3.

Specific examples of the compounds represented by General Formula (1) are as follows.

In General Formula (1), examples of the substituent for R₁ include alkyl groups such as methyl group, ethyl group, propyl group and butyl group; aryl groups such as phenyl group and naphthyl group; aralkyl groups such as benzyl group, phenethyl group and naphthylmethyl group; and alkoxy groups such as methoxy group, ethoxy group and propoxy group. These may be replaced by a halogen atom, a nitro group, a cyano group, alkyl groups such as methyl group and ethyl group, alkoxy groups such as methoxy group and ethoxy group, aryloxy groups such as phenoxy group, aryl groups such as phenyl group and naphthyl group, aralkyl groups such as benzyl group and phenethyl group, and the like.

Amongst the examples of the substituent for R₁, halogen atom and methyl group are particularly favorable.

Ar₃ and Ar₄ each denote a substituted or unsubstituted aryl group; in the present invention, examples of the substituted or unsubstituted aryl group include condensed polycyclic hydrocarbon groups, non-condensed cyclic hydrocarbon groups and heterocyclic groups.

The condensed polycyclic hydrocarbon groups are preferably ones whose rings are formed from 18 or fewer carbon atoms each, exemplified by pentanyl group, indenyl group, naphthyl group, azulenyl group, heptalenyl group, biphenylenyl group, as-indacenyl group, s-indacenyl group, fluorenyl group, acenaphthylenyl group, pleiadenyl group, acenaphthenyl group, phenalenyl group, phenanthryl group, anthryl group, fluoranthenyl group, acephenanthrylenyl group, aceanthrylenyl group, triphenylel group, pyrenyl group, crycenyl group and naphthacenyl group.

Examples of the non-condensed cyclic hydrocarbon groups include monovalent groups derived from monocyclic hydrocarbon compounds such as benzene, diphenyl ether, polyethylene diphenyl ether, diphenyl thioether and diphenyl sulfone; monovalent groups derived from non-condensed polycyclic hydrocarbon compounds such as biphenyl, polyphenyl, diphenylalkane, diphenylalkene, diphenylalkyne, triphenylmethane, distyrylbenzene, 1,1-diphenyl cycloalkane, polyphenylalkane and polyphenylalkene; and monovalent groups derived from cyclic assembly hydrocarbon compounds such as 9,9-diphenylfluorene.

Examples of the heterocyclic groups include monovalent groups derived from carbazole, dibenzofuran, dibenzothiophene, oxadiazole and thiadiazole.

The aryl groups denoted by Ar₃ and Ar₄ may have such substituents as shown below.
(1) Halogen atom, cyano group, nitro group and the like.
(2) Alkyl groups, preferably the straight-chain or branched-chain alkyl groups having 1 to 12 carbon atoms, especially 1 to 8 carbon atoms, even more preferably 1 to 4 carbon atoms. Each of these alkyl groups may have a fluorine atom; a hydroxyl group; a cyano group; any of the alkoxy groups having 1 to 4 carbon atoms; a phenyl group; or a phenyl group replaced by a halogen atom, any of the alkyl groups having 1 to 4 carbon atoms or any of the alkoxy groups having 1 to 4 carbon atoms. Specific examples thereof include methyl group, ethyl group, n-butyl group, i-propyl group, t-butyl group, s-butyl group, n-propyl group, trifluoromethyl group, 2-hydroxyethyl group, 2-ethoxyethyl group, 2-cyanoethyl group, 2-methoxyethyl group, benzyl group, 4-chlorobenzyl group, 4-methylbenzyl group and 4-phenylbenzyl group.
(3) Alkoxy groups (—OR₂); R₂ denotes any of the alkyl groups defined in (2). Specific examples thereof include methoxy group, ethoxy group, n-propoxy group, i-propoxy group, t-butoxy group, n-butoxy group, s-butoxy group, i-butoxy group, 2-hydroxyethoxy group, benzyloxy group and trifluoromethoxy group.
(4) Aryloxy groups; examples of the aryl groups include phenyl group and naphthyl group. Each of these is allowed to contain as a substituent any of the alkoxy groups having 1 to 4 carbon atoms, any of the alkyl groups having 1 to 4 carbon atoms, or a halogen atom. Specific examples thereof include phenoxy group, 1-naphthyloxy group, 2-naphthyloxy group, 4-methoxyphenoxy group and 4-methylphenoxy group.
(5) Alkylmercapto groups or arylmercapto groups; specific examples thereof include methylthio group, ethylthio group, phenylthio group and p-methylphenylthio group.
(6)

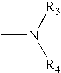

where each one of R₃ and R₄ independently denotes a hydrogen atom, any of the alkyl groups defined in (2), or an aryl group. Examples of the aryl group include phenyl group, biphenyl group and naphthyl group. Each of these is allowed to contain as a substituent any of the alkoxy groups having 1 to 4 carbon atoms, any of the alkyl groups having 1 to 4 carbon atoms, or a halogen atom. R₃ and R₄ may together form a ring.

Specific examples thereof include amino group, diethylamino group, N-methyl-N-phenylamino group, N,N-diphenylamino group, N,N-di(tolyl)amino group, dibenzyl amino group, piperidino group, morpholino group and pyrrolidino group.
(7) Alkylenedioxy groups, alkylenedithio groups, etc. such as methylenedioxy group and methylenedithio group.
(8) Substituted or unsubstituted styryl groups, substituted or unsubstituted β-phenylstyryl groups, diphenylaminophenyl group, ditolylaminophenyl group and the like.

The arylene groups denoted by Ar₁ and Ar₂ are divalent groups derived from the aryl groups denoted by Ar₃ and Ar₄.

X denotes a single bond, a substituted or unsubstituted alkylene group, a substituted or unsubstituted cycloalkylene group, a substituted or unsubstituted alkylene ether group, an oxgen atom, a sulfur atom or a vinylene group. However, it is desirable that X not be a single bond when “m” is 0.

The substituted or unsubstituted alkylene group is selected from the straight-chain or branched-chain alkylene groups having 1 to 12 carbon atoms, preferably 1 to 8 carbon atoms, more preferably 1 to 4 carbon atoms. Each of these alkylene groups may have a fluorine atom; a hydroxyl group; a cyano group; any of the alkoxy groups having 1 to 4 carbon atoms; a phenyl group; or a phenyl group replaced by a halogen atom, any of the alkyl groups having 1 to 4 carbon atoms or any of the alkoxy groups having 1 to 4 carbon atoms. Specific examples thereof include methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-methoxyethylene group, benzylidene group, phenylethylene group, 4-chlorophenylethylene group, 4-methylphenylethylene group and 4-biphenylethylene group. The substituted or unsubstituted cycloalkylene group is selected from the cyclic alkylene groups having 5 to 7 carbon atoms. Each of these cyclic alkylene groups may have a fluorine atom, a hydroxyl group, any of the alkyl groups having 1 to 4 carbon atoms, or any of the alkoxy groups having 1 to 4 carbon atoms. Specific examples thereof include cyclohexylidene group, hexylene group and 3,3-dimethylcyclohexylidene group.

The substituted or unsubstituted alkylene ether group is selected from ethyleneoxy, propyleneoxy, ethylene glycol, propylenglycol, diethylene glycol, tetraethylene glycol and tripropyleneglycol. Each one of the alkylene ether groups and the alkylene groups may have a substituent such as hydroxyl group, methyl group or ethyl group.

The vinylene group is represented by

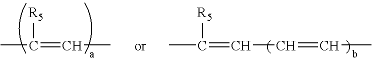

where R₅ denotes a hydrogen atom, an alkyl group (any of the alkyl groups defined in (2)) or an aryl group (any of the aryl groups denoted by Ar₃ and Ar₄), “a” denotes an integer of 1 or 2, and “b” denotes an integer of 1 to 3.

Z denotes a substituted or unsubstituted alkylene group, a substituted or unsubstituted alkylene ether divalent group, or an alkyleneoxycarbonyl divalent group.

Examples of the substituted or unsubstituted alkylene group include one similar to the alkylene group denoted by X.

Examples of the substituted or unsubstituted alkylene ether divalent group include a divalent group of the alkylene ether group denoted by X.

Examples of the alkyleneoxycarbonyl divalent group include caprolactone modified divalent group.

The monofunctional radical polymerizable compound having a charge transporting structure in the present invention plays an important role in adding to charge transporting performance of the protective layer, and the content thereof in the protective layer is 20% by mass to 80% by mass, preferably 30% by mass to 70% by mass. When the content thereof is less than 20% by mass, the charge transporting performance of the protective layer cannot be sufficiently retained, and deteriorations in electrical properties such as decrease in sensitivity and increase in residual potential tend to arise through repetitive use. When it is greater than 80% by mass, the content of the trifunctional monomer having no charge transporting structure decreases, which causes the crosslinking bond density to decrease, and thus high abrasion resistance cannot be performed. Required electrical properties and abrasion resistance vary according to the process used, thereby also causing the protective layer of the photoconductor to vary in thickness, and it is therefore impossible to state the range of the content unequivocally; nevertheless, the range of 30% by mass to 70% by mass is most desirable in view of a balance between electrical properties and abrasion resistance.

Specific examples of the present invention's monofunctional radical polymerizable compound having a charge transporting structure include, but not limited to, the following compounds.

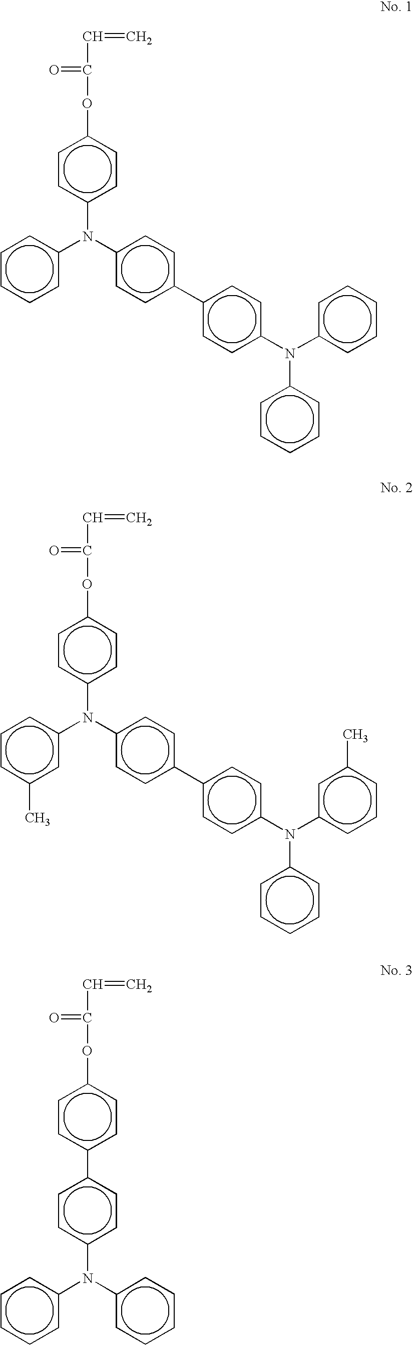

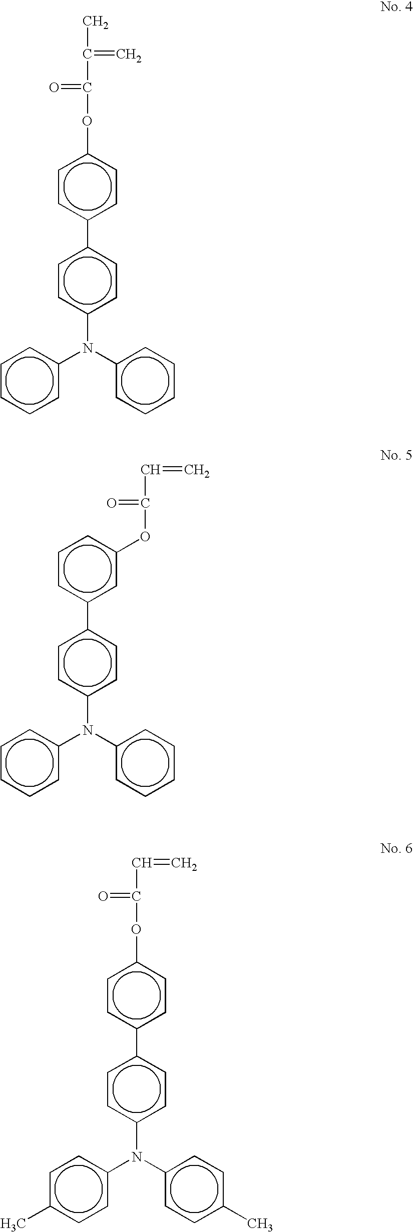

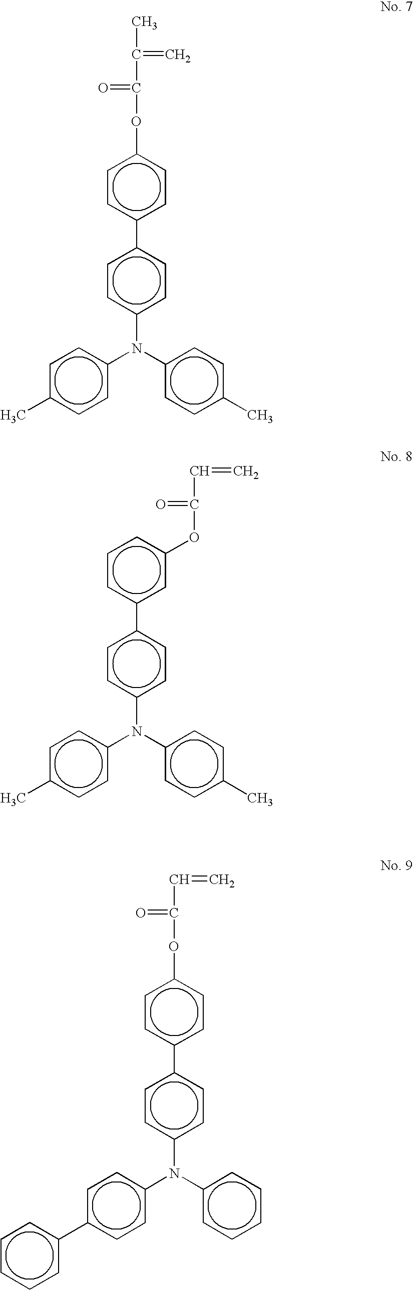

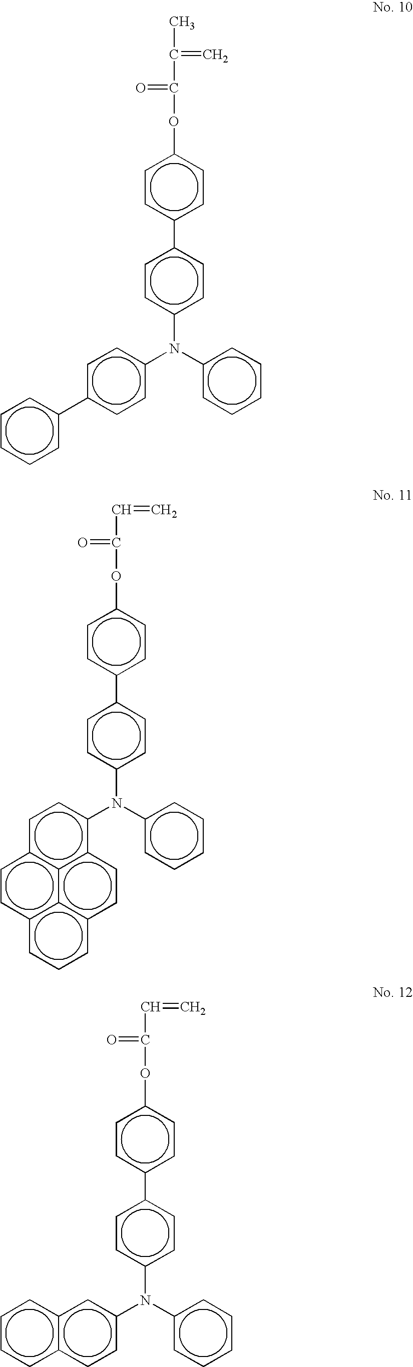

The following explains an image forming apparatus used in the present invention, with reference to the drawings.

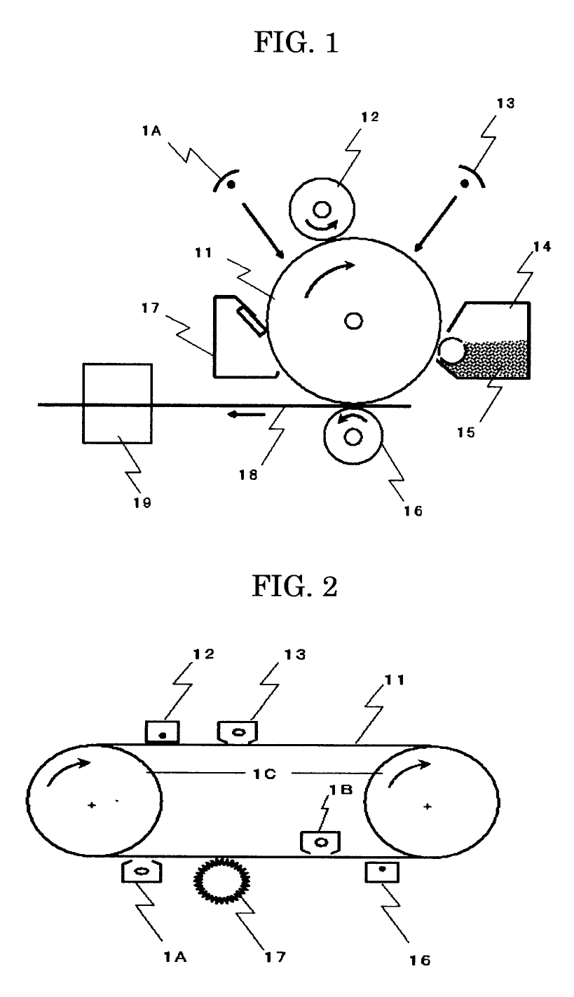

FIG. 1 is a schematic diagram for explaining an image forming apparatus of the present invention, and modified examples to be later described are also within the scope of the present invention.

In FIG. 1, a photoconductor 11 is an electrophotographic photoconductor on which the crosslinked-type resinous protective layer according to the present invention is laid. Although the photoconductor 11 is shaped like a drum, it may be shaped like a sheet or an endless belt.

For a charging unit 12, a conventional unit such as a corotron charger, a scorotron charger, a solid-state charger or a charging roller is used. A charging unit placed in contact with or in the vicinity of a photoconductor is suitably used in view of reduction in power consumption. In particular, a charging mechanism placed in the vicinity of a photoconductor, with certain space provided between the photoconductor and the surface of a charging unit, is desirable in that it can prevent the charging unit from being polluted. For a transfer unit 16, it is generally possible to use any of the above-mentioned chargers; however, a charger which utilizes both a transfer charger and a separation charger is more effective.

Examples of light sources used for an exposing unit 13, a charge-eliminating unit 1A and so forth include most light-emitting sources such as fluorescent lamps, tungsten lamps, halogen lamps, mercury-vapor lamps, sodium-vapor lamps, light-emitting diodes (LEDs), laser diodes (LDs) and electroluminescences (ELs). It is also possible to use filters such as a sharp-cut filter, a band-pass filter, a near-infrared cut filter, a dichroic filter, an interference filter and a color temperature conversion filter so as to apply light in a desired wavelength range exclusively.

A toner 15 developed on the photoconductor by a developing unit 14 is transferred to a printing medium 18 such as a sheet of paper for printing or a slide for an OHP; however, not all of the toner 15 is transferred, and some of it remains on the photoconductor. Such toner is removed from the photoconductor by a cleaning unit 17. For the cleaning unit, a rubber cleaning blade, a brush such as a fur brush or magnetic fur brush, or the like can be used.

When the electrophotographic photoconductor is positively (negatively) charged and an image is exposed, a positive (negative) latent electrostatic image is formed on the photoconductor surface. Once this positive (negative) latent electrostatic image is developed with a toner having a negative (positive) polarity (electroscopic fine particles), a positive image is obtained, whereas once it is developed with a toner having a positive (negative) polarity, a negative image is obtained. A conventional method is applied to the developing means, and a conventional method is applied to the charge-eliminating means as well.

FIG. 2 shows another example of an electrophotographic process according to the present invention.

In FIG. 2, a photoconductor 11 is an electrophotographic photoconductor on which the crosslinked-type resinous protective layer according to the present invention is laid. Although the photoconductor 11 is shaped like a belt, it may be shaped like a drum, a sheet or an endless belt. The photoconductor 11 is driven by a pair of drive units 1C and repeatedly subjected to charging by a charging unit 12, image exposure by an exposing unit 13, development (not shown in the figure), image transfer by a transfer unit 16, pre-cleaning exposure by a pre-cleaning exposing unit, cleaning by a cleaning unit 17 and charge elimination by a charge-eliminating unit 1A. In FIG. 2, light irradiation for the pre-cleaning exposure is conducted from the substrate side of the photoconductor (in this case, the substrate transmits light).

The aforesaid electrophotographic process merely exemplifies an embodiment in the present invention, and it goes without saying that other embodiments can also be employed. For example, although the pre-cleaning exposure is conducted from the substrate side in FIG. 2, it may be conducted from the photosensitive layer side; also, the image exposure and irradiation with charge-eliminating light may be conducted from the substrate side. Meanwhile, although image exposure, pre-cleaning exposure and charge-eliminating exposure are depicted as light irradiation steps, it is also possible to irradiate the photoconductor with light by additionally providing pre-transfer exposure, preexposure for image exposure and other conventional light irradiation steps.

The foregoing image forming units may be installed in a stationary manner inside a copier, a facsimile or a printer;

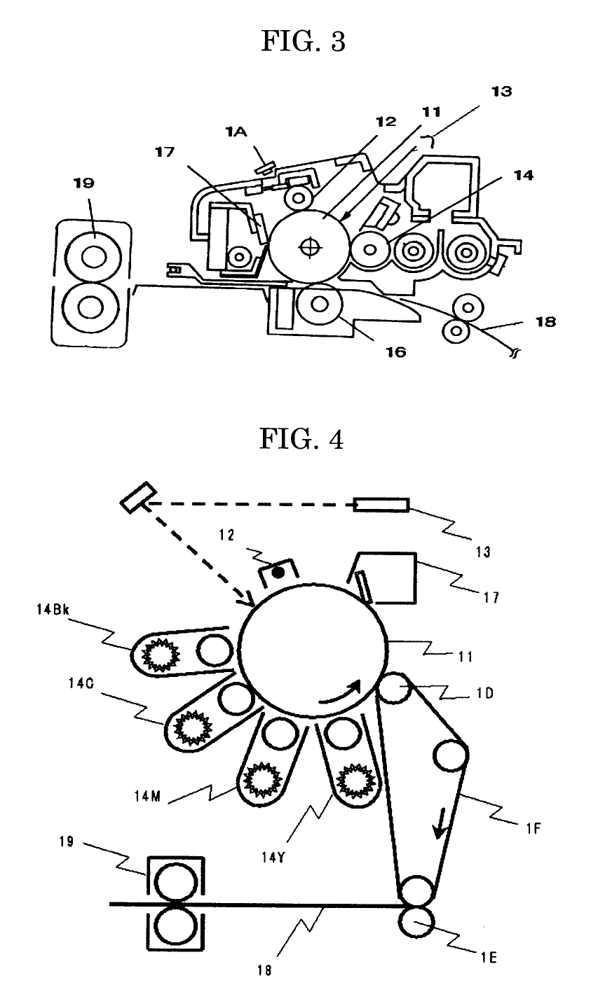

alternatively, they may be installed in the form of a process cartridge inside any of those apparatuses. There can be many examples of the shape of the process cartridge, with a typical example thereof being shown in FIG. 3. Although the photoconductor 11 is shaped like a drum, it may be shaped like a sheet or an endless belt.

FIG. 4 shows yet another example of the image forming apparatus according to the present invention. In this image forming apparatus, a charging unit (12); an exposing unit (13); developing units (14Bk, 14C, 14M and 14Y) for toners of black (Bk), cyan (C), magenta (M) and yellow (Y) respectively; an intermediate transfer belt (1F) that is an intermediate transfer medium; and a cleaning unit (17) are disposed in the vicinity of a photoconductor (11). Here, the letters Bk, C, M and Y in the figure correspond to the colors of the toners, and these letters will be added according to necessity or suitably omitted. The photoconductor 11 is an electrophotographic photoconductor on which the crosslinked-type resinous protective layer according to the present invention is laid. The developing units 14Bk, 14C, 14M and 14Y can be independently controlled, and only the developing unit which is to form an image is driven. A toner image formed on the photoconductor 11 is transferred onto the intermediate transfer belt (1F) by a first transfer unit (1D) placed inside the intermediate transfer belt (1F). The first transfer unit 1D is placed in such a manner as to be able to come into and out of contact with the photoconductor 11 and brings the intermediate transfer belt 1F into contact with the photoconductor 11 only at the time of transfer operation. Images of each color are sequentially formed, and toner images superimposed onto one another on the intermediate transfer belt IF are transferred onto a printing medium 18 at one time by a second transfer unit 1E and then fixed by a fixing unit 19 so as to form an image. The second transfer unit 1E, too, is placed in such a manner as to be able to come into and out of contact with the intermediate transfer belt 1F and comes into contact with the intermediate transfer belt 1F only at the time of transfer operation.

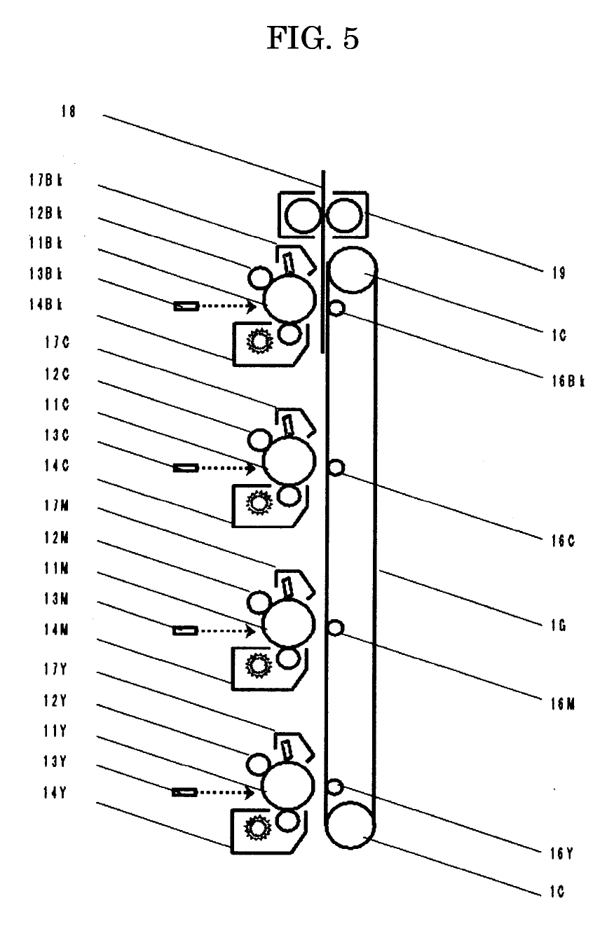

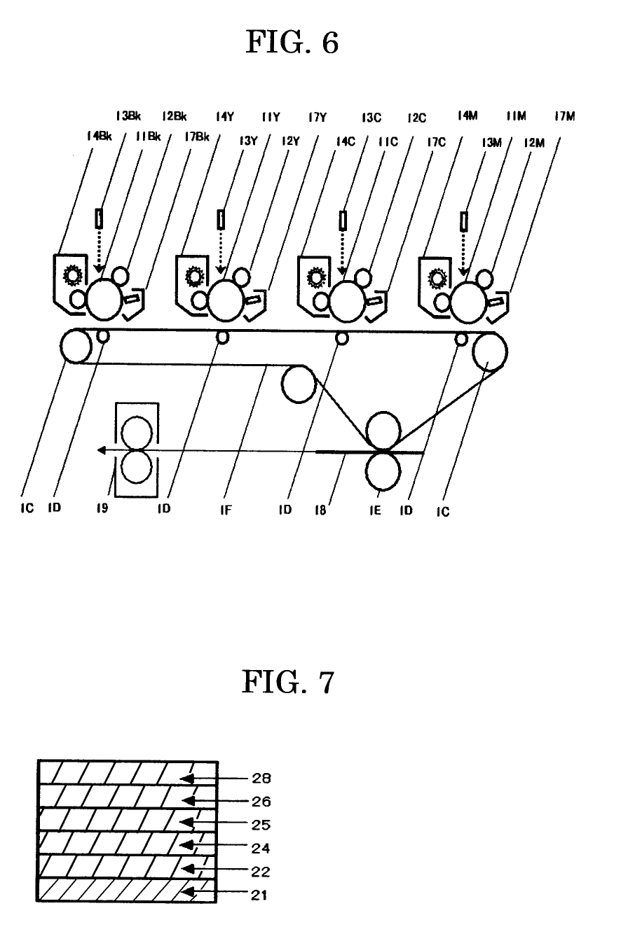

In an image forming apparatus based upon a transfer drum system, since toners images of each color are sequentially transferred onto a transfer material electrostatically adsorbed on a transfer drum, there is such a restriction on the transfer material that printing cannot be carried out on thick paper; whereas, in such an image forming apparatus based upon an intermediate transfer system as shown in FIG. 4, since toner images of each color are superimposed onto one another on the intermediate transfer medium 1F, the image forming apparatus is characterized in that it is free of restrictions on a transfer material. Such an intermediate transfer system can be applied to the image forming apparatuses in FIGS. 1 to 3 earlier described and FIG. 5 to be later described (FIG. 6 shows a specific example) as well as to the apparatus in FIG. 4.

FIG. 5 shows still another example of the image forming apparatus according to the present invention. This image forming apparatus is classified as a type using toners of four colors that are yellow (Y), magenta (M), cyan (C) and black (Bk), and image forming units are independently provided for these colors. Also, photoconductors (11Y, 11M, 11C and 11Bk) for each color are provided. The photoconductor 11 used in this image forming apparatus is an electrophotographic photoconductor on which the crosslinked-type resinous protective layer according to the present invention is laid. A charging unit 12, an exposing unit 13, a developing unit 14, a cleaning unit 17 and the like are disposed in the vicinity of the photoconductors 11Y, 11M, 11C and 11Bk. Also, a conveyance transfer belt 1G serving as a transfer material bearing member which comes into and out of contact with the transfer positions of the photoconductors 11Y, 11M, 11C and 11Bk linearly disposed is supported on a pair of drive units 1C. Transfer units 16 are disposed in transfer positions opposed to the photoconductors 11Y, 11M, 11C and 11Bk, with this conveyance transfer belt 1G sandwiched in between.

Since an image forming apparatus based upon a tandem system as in FIG. 5 has the photoconductors 11Y, 11M, 11C and 11Bk for each color and sequentially transfers toner images of each color onto a printing medium 18 held by the conveyance transfer belt 1G, the image forming apparatus is capable of outputting a full-color image at much higher speed than a full-color image forming apparatus having only one photoconductor.

Next, the electrophotographic photoconductor used in the present invention will be explained in detail with reference to the drawings; it should, however, be noted that the structure of the electrophotographic photoconductor in the present invention is not confined to the following.

FIG. 7 is a cross-sectional view showing a structural example of the electrophotographic photoconductor used in the present invention: a charge blocking layer (22), an under layer (24), a charge generating layer (25) formed mainly of a charge generating material, a charge transporting layer (26) formed mainly of a charge transporting material, and a protective layer (28) according to the present invention are laid on a conductive substrate (21) in this order. However, the charge blocking layer and the under layer are not necessarily required. Also, the charge generating layer and the charge transporting layer do not necessarily have to be formed independently of each other, and they can be formed as a photosensitive layer.

As the conductive substrate 21, what can be used is a substrate showing such conductivity as 10¹⁰ Ω-cm or less in volume resistance. Examples thereof include a construction formed by coating a film-like or cylindrical piece of plastic or paper with a metal such as aluminum, nickel, chrome, Nichrome, copper, silver, gold, platinum or iron or with an oxide such as tin oxide or indium oxide by means of vapor deposition or sputtering; a plate of aluminum, aluminum alloy, nickel, stainless, etc.; and a tube constructed by forming the plate into a mother tube by means of a process such as a drawing-ironing process, impact ironing process, extruded ironing process, extruded drawing process or cutting process and then surface-treating the mother tube by means of cutting, superfinishing, polishing, etc.

Firstly, the charge blocking layer 22 provided mainly for the purpose of reducing charge injection from the conductive substrate will be described.

The charge blocking layer is a layer having the function of preventing a charge of an opposite polarity induced to an electrode (the conductive substrate) when the photoconductor is charged from being injected into a photosensitive layer from the substrate, and is provided mainly for the purpose of reducing background smear. When the photoconductor is negatively charged, the charge blocking layer has the function of preventing hole injection, and when the photoconductor is positively charged, it has the function of preventing electron injection. It also has the effect of enhancing concealment of defects of the mother tube and heightens the effect of reducing background smear. Thus, since reduction of charge movement is required in order to achieve these purposes, it is desirable that the charge blocking layer not contain inorganic pigment and be formed solely of a highly insulative resin.

Examples of the charge blocking layer include an anode oxide coating typified by an aluminum oxide layer; an inorganic-type insulating layer typified by SiO; a layer formed of a glassy network of a metal oxide as described in JP-A No. 03-191361; a layer formed of polyphosphazene as described in JP-A No. 03-141363; a layer formed of an aminosilane reaction product as described in JP-A No. 3-101737; a layer formed of an insulative binder resin; and a layer formed of a curable binder resin. Amongst these layers, the layer formed of an insulative binder resin and the layer formed of a curable binder resin, which are able to be formed in accordance with a wet coating method, can be suitably used. The charge blocking layer is used with the under layer and the photosensitive layer laid thereon; therefore, when these layers are provided by a wet coating method, it is important that the charge blocking layer be formed of such a material or have such a structure as can prevent its coating film from being corroded by coating solvents for the under layer and the photosensitive layer.

Examples of usable binder resins include thermoplastic resins and thermosetting resins such as polyamide, polyester and vinyl chloride-vinyl acetate copolymer; for example, it is possible to use a thermosetting resin formed by thermally polymerizing a compound containing a plurality of active hydrogen atoms (hydrogen atoms in —OH group, —NH₂ group, —NH group, etc.) and a compound containing a plurality of isocyanate groups and/or a compound containing a plurality of epoxy groups. In this case, examples of the compound containing a plurality of active hydrogen atoms include acrylic resins containing active hydrogen, such as polyvinyl butyral, phenoxy resin, phenol resin, polyamide, polyester, polyethylene glycol, polypropylene glycol, polybutylene glycol and hydroxyethyl methacrylate. Examples of the compound containing a plurality of isocyanate groups include tolylenediisocyanate, hexamethylene diisocyanate, diphenylmethane diisocyanate, etc. and prepolymers thereof. Examples of the compound containing a plurality of epoxy groups include bisphenol A type epoxy resin.

Also, the following can be used as binder resins: a thermosetting resin formed by thermally polymerizing an oil-free alkyd resin and an amino resin such as butylated melamine resin; and further, a photocurable resin formed for example by combining a resin having an unsaturated bond, such as a polyurethane having an unsaturated bond or an unsaturated polyester, and a photopolymerization initiator such as a thioxanthone-based compound or methylbenzyl formate. Since such alcohol-soluble resins and thermosetting resins are highly insulative, and ketone-based solvents are used in large amounts for solutions applied onto layers thereon, their films do not dissolve at the time of coating and the films are uniformly maintained. Therefore, such alcohol-soluble resins and thermosetting resins are superior in uniformity and in the stability of the effect of reducing background smear.

In the present invention, polyamides are favorable amongst these resins, with N-methoxymethylated nylon being most favorable. Polyamide resins are highly effective in reducing charge injection and have little effect on residual potential. Also, these polyamide resins are soluble in alcohols and insoluble in solvents other than alcohols, and make it possible to form thin films uniformly in immersion coating, thereby being superior in coating capability. In particular, since these intermediate layers need to be made thin so as to minimize the effects of the increase in residual potential, and uniformity of layer thickness is also required, coating capability is vital in stabilizing image quality.

In general, alcohol-soluble resins greatly depend upon humidity; thus, they become high in resistance and cause a rise in residual potential at low humidity, and they become low in resistance and cause charge reduction at high humidity, thereby presenting such a serious problem that their dependency upon the environment is great. However, amongst polyamide resins, N-methoxymethylated nylon exhibits great insulating properties, is very superior in the capability of blocking out a charge injected from a conductive substrate, has little effect on residual potential, is far less dependent upon the environment, and can always maintain stable image quality regardless of the use condition of an image forming apparatus; therefore, N-methoxymethylated nylon can be most suitably used when an under layer is laid thereon. In addition, when N-methoxymethylated nylon is used, residual potential is less dependent upon layer thickness, so that it becomes possible to reduce undesirable effects on residual potential and also to heighten the effect of reducing background smear.

Although not particularly limited, the substitution ratio of a methoxymethyl group in the N-methoxymethylated nylon is preferably 15 mol % or greater. The above-mentioned effects obtained by using the N-methoxymethylated nylon are influenced by the degree of methoxymethylation; when the substitution ratio of a methoxymethyl group is lower than this degree, the dependency of the N-methoxymethylated nylon upon humidity tends to increase, and white turbidity tends to be seen when the N-methoxymethylated nylon is used in an alcohol solution, thereby possibly causing the temporal stability of a coating solution to decrease slightly.

In the present invention, the N-methoxymethylated nylon can be solely used; alternatively, it is possible to add a crosslinking agent and an acid catalyst thereto depending upon the situation. A commercially-supplied material such as a conventional melamine resin or isocyanate resin is used for the crosslinking agent, and an acidic catalyst is used for the catalyst, which allows a general-purpose catalyst such as tartaric acid to be used. However, it should be noted that since the addition of the acid catalyst may possibly diminish the insulating properties of an intermediate layer and lessen the effect of reducing background smear, it is necessary for the added amount of the acid catalyst to be very small. The added amount is preferably 5% by mass or less to the amount of resin. Also, it is possible to mix an additional binder resin into the constituents depending upon the situation. For the additional binder resin able to be mixed, an alcohol-soluble polyamide resin is used, which may possibly increase the temporal stability of a solution.

It is also possible to add a conductive polymer and add a resin or low-molecular compound with acceptor (donor) properties and other additives according to the charge polarity, which may possibly be an effective means of reducing residual potential. However, it should be noted that when an over layer is laid by means of immersion coating, those additives may possibly dissolve, and so it is necessary to make the added amount thereof as small as possible.

It is appropriate that the thickness of the charge blocking layer be equal to or greater than 0.1 μm and less than 2.0 μm, preferably in the range of 0.3 μm to 2.0 μm or so. When the thickness of the charge blocking layer becomes great, there is a sharp rise in residual potential especially at low humidity and at low temperatures as charging and exposure are repeated; meanwhile, when the thickness is too small, the effects of blocking capability are lessened. An agent, a solvent, an additive, a curing accelerator and the like necessary for curing (crosslinkage) are added to the charge blocking layer according to necessity, and the charge blocking layer is formed on a base by blade coating, an immersion coating method, spray coating, beat coating, a nozzle coating method or the like in accordance with an ordinary procedure. After applied, the charge blocking layer is dried or cured by a drying process or a curing process involving heating, light, etc.

Next, the under layer 24 will be explained. The underlayer is provided for the purpose of improving adhesion, preventing moire, improving coating capability of an over layer, reducing residual potential, preventing charge injection from the conductive substrate and so forth.

In general, the under layer is formed mainly of a resin; in view of the fact that a photosensitive layer is applied over the resin with the use of a solvent, it is desirable that the resin be a resin which is highly insoluble in ordinary organic solvents. Examples of such a resin include water-soluble resins such as polyvinyl alcohol, casein and sodium polyacrylate; alcohol-soluble resins such as copolymerized nylon and methoxymethylated nylon; and curable resins constituting three-dimensional networks, such as polyurethane, melamine resin, alkyd-melamine resin and epoxy resin.

Also, fine powder derived from a metal oxide such as titanium oxide, silica, alumina, zirconium oxide, tin oxide or indium oxide, a metal sulfide, a metal nitride or the like may be added to the under layer.

The under layer can be formed using a certain solvent and a certain coating method, as can the after-mentioned photosensitive layer.

Further, a metal oxide layer formed using a silane coupling agent, a titanium coupling agent, a chrome coupling agent or the like and formed, for example, in accordance with a sol-gel method can also be effectively used for the under layer.

In addition, a layer provided by anodically oxidizing alumina, or a layer provided by subjecting to a vacuum thin film producing method an organic substance such as polyparaxylylene (parylene) or an inorganic substance such as silicon oxide, tin oxide, titanium oxide, ITO or ceria can also be suitably used for the under layer.

It is appropriate that the under layer be 0.1 μm to 5 μm in thickness.

Also in the present invention, it is possible to add an antioxidant, a plasticizer, an ultraviolet absorber, a low-molecular charge transporting material and a leveling agent to layers so as to improve the gas barrier properties and environment resistance of the photoconductor protective layer.

Typical materials for these compounds are written below.

Examples of the antioxidant able to be added to the layers include, but not limited to, the compounds belonging to (a) to (d) below.

### (a) Phenolic Antioxidants

2,6-di-t-butyl-p-cresol, 2,4,6-tri-t-butylphenol, n-octadecyl-3-(4′-hydroxy-3′,5′-di-t-butylphenol)propionate, styrenated phenol, 4-hydroxymethyl-2,6-di-t-butylphenol, 2,5-di-t-butylhydroquinone, cyclohexylphenol, butylhydroxyanisole, 2,2′-methylene-bis(4-ethyl-6-t-butylphenol), 4,4′-i-propylidenebisphenol, 1,1-bis(4-hydroxyphenyl)cyclohexane, 4,4′-methylene-bis(2,6-di-t-butylphenol), 2,6-bis(2′-hydroxy-3′-t-butyl-5′-methylbenzyl)-4-methylphenol, 1,1,3-tris(2-methyl-4-hydroxy-5-t-butylphenyl)butane, 1,3,5-trismethyl-2,4,6-tris(3,5-di-t-butyl-4-hydroxybenzyl)benzene, tetrakis [methylene-3-(3,5-di-t-butyl-4-hydroxyphenyl)propionate]methane, tris(3,5-di-t-butyl-4-hydroxyphenyl)isocyanate, tris[β-(3,5-di-t-butyl-4-hydroxyphenyl)propionyl-oxyethyl]isocyanate, 4,4′-thiobis(3-methyl-6-t-butylphenol), 2,2′-thiobis(4-methyl-6-t-butylphenol) and 4,4′-thiobis(4-methyl-6-t-butylphenol)

### (b) Amine-Based Antioxidants

phenyl-α-naphthylamine, phenyl-β-naphthylamine, N,N′-diphenyl-p-phenylenediamine, N,N′-di-β-naphthyl-p-phenylenediamine, N-cyclohexyl-N′-phenyl-p-phenylenediamine, N-phenylene-N′-i-propyl-p-phenylenediamine, aldol-α-naphthylamine and 6-ethoxy-2,2,4-trimethyl-1,2-dihydroquinoline

### (c) Sulfuric Antioxidants

thiobis(β-naphthol), thiobis(N-phenyl-β-naphthylamine), 2-mercaptobenzothiazole, 2-mercaptobenzimidazole, dodecylmercaptan, tetramethylthiuram monosulfide, tetramethylthiuram disulfide, nickeldibutylthiocarbamate, isopropylxanthate, dilaurylthiodipropionate and distearylthiodipropionate

### (d) Phosphoric Antioxidants

triphenyl phosphite, diphenyl decyl phosphite, phenyl isodecyl phosphite, tri(nonylphenyl)phosphite, 4,4′-butylidene-bis(3-methyl-6-t-butylphenyl-ditridecyl phosphite), distearyl-pentaerythritol diphosphite and trilauryl trithiophosphite

Examples of the plasticizer able to be added to the layers include, but not limited to, the compounds belonging to (a) to (m) below.

### (a) Phosphoric Acid Ester Based Plasticizers

triphenyl phosphate, tricresyl phosphate, trioctyl phosphate, octyldiphenyl phosphate, trichlorethyl phosphate, cresyldiphenyl phosphate, tributyl phosphate, tri-2-ethylhexyl phosphate, triphenyl phosphate and so forth

### (b) Phthalic Acid Ester Based Plasticizers

dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzyl phthalate, butyllauryl phthalate, methyloleyl phthalate, octyldecyl phthalate, dibutyl fumarate, dioctyl fumarate and so forth

### (c) Aromatic Carboxylic Acid Ester Based Plasticizers

trioctyl trimellitate, tri-n-octyl trimellitate, octyl oxybenzoate and so forth

### (d) Aliphatic Dibasic Acid Ester Based Plasticizers

dibutyl adipate, di-n-hexyl adipate, di-2-ethylhexyl adipate, di-n-octyl adipate, n-octyl-n-decyl adipate, diisodecyl adipate, dicapryl adipate, di-2-ethylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophthalate, di-n-octyl tetrahydrophthalate and so forth

### (e) Fatty Acid Ester Derivatives

butyl oleate, glycerin monooleic acid ester, methyl acetylricinolate, pentaerythritol ester, dipentaerythritol hexaester, triacetin, tributyrin and so forth

### (f) Oxyacid Ester Based Plasticizers

methyl acetylricinolate, butyl acetylricinolate, butyl phthalyl butyl glycolate, tributyl acetylcitrate and so forth

### (g) Epoxy Plasticizers

epoxidized soybean oil, epoxidized linseed oil, butyl epoxystearate, decyl epoxystearate, octyl epoxystearate, benzyl epoxystearate, dioctyl epoxyhexahydrophthalate, didecyl epoxyhexahydrophthalate and so forth

### (h) Dihydric Alcohol Ester Based Plasticizers

diethylene glycol dibenzoate, triethylene glycol di-2-ethylbutyrate and so forth

### (i) Chlorine-Containing Plasticizers

chlorinated paraffins, chlorinated diphenyl, chlorinated fatty acid methyl, methoxy chlorinated fatty acid methyl and so forth

### (j) Polyester-Based Plasticizers

polypropylene adipate, polypropylene sebacate, polyester, acetylated polyester and so forth

### (k) Sulfonic Acid Derivatives

p-toluenesulfonamide, o-toluenesulfonamide, p-toluenesulfonethylamide, o-toluenesulfonethylamide, toluenesulfon-N-ethylamide, p-toluenesulfon-N-cyclohexylamide and so forth

### (l) Citric Acid Derivatives

triethyl citrate, triethyl acetylcitrate, tributyl citrate, tributyl acetylcitrate, tri-2-ethylhexyl acetylcitrate, n-octyldecyl acetylcitrate and so forth

### (m) Others

terphenyl, partially-hydrogenated terphenyl, camphor, 2-nitrodiphenyl, dinonylnaphthalene, methyl abietate and so forth Examples of the ultraviolet absorber able to be added to the layers include, but not limited to, the compounds belonging to (a) to (f) below.

### (a) Benzophenone-Based Compounds

2-hydroxybenzop he none, 2,4-dihydroxybenzophe none, 2,2′,4-trihydroxybenzophenone, 2,2′,4,4′-tetrahydroxybenzophenone, 2,2′-dihydroxy-4-methoxybenzophenone and so forth

### (b) Salicylate-Based Compounds

phenyl salicylate, 2,4-di-t-butylphenyl-3,5-di-t-butyl-4-hydroxybenzoate and so forth

### (c) Benzotriazole-Based Compounds

(2′-hydroxyphenyl)benzotriazole, (2′-hydroxy-5′-methylphenyl)benzotriazole, (2′-hydroxy-3′-t-butyl-5′-methylphenyl)-5-chlorobenzotriazole and so forth.

### (d) Cyanoacrylate-Based Compounds

ethyl-2-cyano-3,3-diphenylacrylate, methyl-2-carbomethoxy-3-(paramethoxy)acrylate and so forth

### (e) Quenchers (Metallic Complex Salt Based Compounds)

nickel [2,2′-thiobis(4-t-octyl)phenolate]normal-butylamine, nickeldibutyldithiocarbamate, cobaltdicyclohexyl dithiophosphate and so forth.

### (f) HALSs (Hindered Amine Light Stabilizers)

bis(2,2,6,6-tetramethyl-4-piperidyl)sebacate, bis(1,2,2,6,6-pentamethyl-4-piperidyl)sebacate, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpyridine, 8-benzyl-7,7,9,9-tetramethyl-3-octyl-1,3,8-triazaspiro[4,5]undecane-2,4-dione, 4-benzoyloxy-2,2,6,6-tetramethylpiperidine and so forth.

Next, the charge generating layer 25 will be explained. The charge generating layer denotes a portion of a laminated photosensitive layer and has the function of generating a charge by means of exposure. Compounds contained in this layer include a charge generating material as a main component. A binder resin may possibly be used for the charge generating layer according to necessity. For the charge generating material, an inorganic material or an organic material can be used.

Examples of the inorganic material include crystalline selenium, amorphous selenium, selenium-tellurium compounds, selenium-tellurium-halogen compounds, selenium-arsenic compounds and amorphous silicon. Suitable examples of the amorphous silicon include silicon with hydrogen-terminated or halogen-terminated dangling bonds, and boron-doped or phosphorus-doped silicon.

For the organic material, a conventionally-known material can be used; examples thereof include metal phthalocyanines such as titanyl phthalocyanine and chlorogallium phthalocyanine, nonmetal phthalocyanines, azlenium salt pigments, methine squarate pigments, symmetric or asymmetric azo pigments having carbazole skeletons, symmetric or asymmetric azo pigments having triphenylamine skeletons, symmetric or asymmetric azo pigments having fluorenone skeletons, and perylene-based pigments. Amongst these, metal phthalocyanines, symmetric or asymmetric azo pigments having fluorenone skeletons, and symmetric or asymmetric azo pigments having triphenylamine skeletons are suitable for the present invention because they all have high quantum efficiency in charge generation. These charge generating materials may be used independently or in combination.

Examples of the binder resin possibly used for the charge generating layer according to necessity include polyamide, polyurethane, epoxy resin, polyketone, polycarbonate, polyarylate, silicone resin, acrylic resin, polyvinyl butyral, polyvinyl formal, polyvinyl ketone, polystyrene, poly-N-vinylcarbazole and polyacrylamide. Amongst these, polyvinyl butyral is most commonly used and is useful. These binder resins may be used independently or in combination.

Also, a high-molecular charge transporting material can be used as the binder resin for the charge generating layer. Further, a low-molecular charge transporting material may be added according to necessity.

Charge transporting materials able to be additionally used for the charge generating layer are classified into electron transport materials and hole transport materials, and further, these charge transporting materials are classified into low-molecular type charge transporting materials and high-molecular type charge transporting materials.

In the present invention, the high-molecular type charge transporting materials are hereinafter referred to as high-molecular charge transporting materials.

Examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-on and 1,3,7-trinitrodibenzothiophene-5,5-dioxide.

These electron transport materials may be used independently or in combination.

Electron-donating materials can be suitably used for the hole transport materials.

Examples thereof include oxazole derivatives, oxadiazole derivatives, imidazole derivatives, triphenylamine derivatives, 9-(p-diethylaminostyrylanthracene), 1,1-bis-(4-dibenzylaminophenol)propane, styrylanthracene, styrylpyrazoline, phenylhydrazones, α-phenylstilbene derivatives, thiazole derivatives, triazole derivatives, phenazine derivatives, acridine derivatives, benzofuran derivatives, benzimidazole derivatives and thiophene derivatives.

These hole transport materials may be used independently or in combination.

Also, the following high-molecular charge transporting materials can, for example, be used: polymers having carbazole rings, such as poly-N-vinylcarbazole; polymers having hydrazone structures, exemplified in Japanese Patent Application Laid-Open (JP-A) No. 57-78402 and so forth; polysilylene polymers exemplified in JP-A No. 63-285552 and so forth; and aromatic polycarbonates exemplified in JP-A Nos. 08-269183, 09-151248, 09-71642, 09-104746, 09-328539, 09-272735, 09-241369, 11-29634, 11-5836, 11-71453, 09-221544, 09-227669, 09-157378, 09-302084, 09-302085, 09-268226, 09-235367, 09-87376, 09-110976 and 2000-38442. These high-molecular charge transporting materials can be used independently or in combination.

Methods for forming the charge generating layer are broadly classified into vacuum thin film producing method, and casting method based upon a solution dispersion system.

Examples of the vacuum thin film producing method include vacuum evaporation method, glow discharge decomposition method, ion plating method, sputtering method, reactive sputtering method and CVD (chemical vapor deposition) method, whereby layers made of the above-mentioned inorganic and organic materials can be suitably formed.

To provide the charge generating layer in accordance with the casting method, any of the inorganic and organic charge generating materials is dispersed, together with a binder resin if necessary, in a solvent such as tetrahydrofuran, cyclohexanone, dioxane, dichloroethane or butanone, by a ball mill, an attritor, a sand mill or the like, and the dispersion solution is appropriately diluted and applied. Amongst these solvents, methyl ethyl ketone, tetrahydrofuran and cyclohexanone are lower in the degree of environmental load than chlorobenzene, dichloromethane, toluene and xylene and are therefore preferable. The dispersion solution can be applied by an immersion coating method, a spray coating method, a beat coating method or the like.

It is appropriate that the thickness of the charge generating layer thus provided be 0.01 μm to 5 μm or so, preferably 0.05 μm to 2 μm.

Next, the charge transporting layer 26 will be explained.

The charge transporting layer denotes a portion of the laminated photosensitive layer, that has the function of injecting and transporting a charge generated by the charge generating layer and the function of neutralizing a surface charge of the photoconductor created by charging. A charge transporting component and a binder component for binding the charge transporting component can be mentioned as main components of the charge transporting layer.

The charge transporting layer can be formed by dissolving or dispersing in a certain solvent a mixture or copolymer which has a charge transporting component and a binder component as main components, and applying and drying this solution. An immersion coating method, a spray coating method, a ring coating method, a roll coater method, a gravure coating method, a nozzle coating method, a screen printing method or the like is employed as a coating method.

Since the sensitivity and charging ability necessary for practical use are to be secured, it is appropriate that the thickness of the charge transporting layer be 15 μm to 40 μm or so, preferably 15 μm to 30 μm or so, or 25 μm or less when great resolving power is required. A protective layer is laid on top of the charge transporting layer; therefore, as to the thickness of the charge transporting layer in this structure, a design for the thickening of a charge transporting layer, which allows for peeling in practical use, is not necessary, and the thinning of the charge transporting layer is thusly made possible.

Examples of a dispersion solvent able to be used in preparing the charge transporting layer coating solution include ketones such as methyl ethyl ketone, acetone, methyl isobutyl ketone and cyclohexanone; ethers such as dioxane, tetrahydrofuran and ethyl cellosolve; aromatic compounds such as toluene and xylene; halogen-containing compounds such as chlorobenzene and dichloromethane; and esters such as ethyl acetate and butyl acetate. Amongst these, methyl ethyl ketone, tetrahydrofuran and cyclohexanone are lower in the degree of environmental load than chlorobenzene, dichloromethane, toluene and xylene and are therefore preferable. These solvents can be used independently or in combination.

Examples of a high-molecular compound able to be used as the binder component of the charge transporting layer include thermoplastic or thermosetting resins such as polystyrene, polyester, polyarylate, polycarbonate, acrylic resin, silicone resin, fluorine resin, epoxy resin, melamine resin, urethane resin, phenol resin and alkyd resin. Amongst these, any one of polystyrene, polyester, polyarylate and polycarbonate often exhibits favorable charge transfer properties when used as the binder component of the charge transporting layer and is therefore useful. Also, since the protective layer is laid on top of the charge transporting layer, it is not necessary for the charge transporting layer to be as mechanically strong as a conventional charge transporting layer. Therefore, materials which are highly transparent but somewhat low in mechanical strength, such as polystyrene, that have been deemed hardly applicable in related art can be effectively utilized for the binder component of the charge transporting layer.

These high-molecular compounds can be used independently or in combination, can be used as copolymers composed of their raw material monomers, and further, can be used being copolymerized with the charge transporting materials.

Note that when one or more other layers such as the protective layer are deposited over the charge transporting layer, it is desirable that a solvent-soluble resin such as polystyrene, polyacrylate resin, polycarbonate or phenol resin be selected for the binder component of the charge transporting layer so as to make unclear the interface between the charge transporting layer and the layer thereon. By making the interface unclear, it becomes possible to prevent the over layer from peeling off through repetitive or long-term use and reduce electrical interface barriers; further, in the case where the over layer is the protective layer, when the protective layer is applied onto the charge transporting layer by means of wet coating, expansion of the charge transporting material contained in the charge transporting layer into the protective layer is induced, and thus accumulation of residual potential can be reduced.

When an electrically inactive high-molecular compound is used in modifying the quality of the charge transporting layer, any of the following compounds is effective: a cardo polymer type polyester having a bulky skeleton, such as FLUON; polyesters such as polyethylene terephthalate and polyethylene naphthalate; a polycarbonate in which atoms/groups at the 3 and 3′ positions of a phenol component of a bisphenol-type polycarbonate are replaced by alkyl groups, such as C-type polycarbonate; a polycarbonate in which a geminal methyl group of a bisphenol A is replaced by a long-chain alkyl group having two or more carbon atoms; a polycarbonate having a biphenyl or biphenyl ether skeleton; polycaprolactones; a polycarbonate having such a long-chain alkyl skeleton as a polycaprolactone (described, for example, in JP-A No. 07-292095); acrylic resins; polystyrenes; and hydrogenated butadienes.

Here, the electrically inactive high-molecular compound denotes a high-molecular compound without a photoconductive chemical structure such as a triarylamine structure.

When any such resin is used together with a binder resin as an additive, it is desirable that the added amount thereof be 50% by mass or less to the total solid content of the charge transporting layer, due to restrictions concerning light decay sensitivity.

Examples of a material able to be used for the charge transporting material include the low-molecular type electron transport materials, the hole transport materials and the high-molecular charge transporting materials.

When any of the low-molecular type charge transporting materials is used, it is appropriate that the amount thereof used be 40 phr to 200 phr, preferably 70 phr to 100 phr or so. When any of the high-molecular charge transporting materials is used, a material formed by copolymerizing 0 part by mass to 200 parts by mass, preferably 80 parts by mass to 150 parts by mass or so, of a resinous component with 100 parts by mass of a charge transporting component can be suitably used.

It is also possible for the charge transporting layer to contain two or more kinds of charge transporting materials.

In particular, photoconductors with protective layers are less advantageous in sensitivity properties than those without protective layers in many cases. To compensate for the foregoing, it is desirable to make the degree of charge transfer high in the charge transporting layer and to make the degree of charge transfer high enough in a low electric field region as well.

To achieve high sensitivity, it is desirable that the amount of the charge transporting component included be 70 phr or greater. Additionally, monomers/dimers of α-phenylstilbene compounds, benzidine compounds and butadiene compounds, and high-molecular charge transporting materials having these structures in their main chains or side chains are mostly materials with high degrees of charge transfer and are therefore useful as charge transporting materials.

It is also possible to add into the charge transporting layer a low-molecular compound such as the antioxidant, the plasticizer, the lubricant or the ultraviolet absorber, and the leveling agent that are mentioned below, according to necessity. These compounds can be used independently or in combination. Use of the low-molecular compound and the leveling agent leads to deterioration in sensitivity in many cases. For this reason, it is appropriate that the amount of the low-molecular compound used be 0.1 phr to 20 phr or so, preferably 0.1 phr to 10 phr and that the amount of the leveling agent used be 0.001 phr to 0.1 phr or so.

Next, the protective layer 28 will be explained.

The protective layer in the present invention denotes an outermost surface layer provided so as to improve the abrasion resistance of the surface of the photosensitive layer and realize reduction in the friction coefficient of the surface. This protective layer is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles.

The protective layer contains such materials as mentioned above.

The protective layer of the present invention is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles; besides these components, it is possible to additionally use monofunctional and difunctional radical polymerizable monomers, a functional monomer and a radical polymerizable oligomer for the purpose of giving functions, for example adjustment of viscosity at the time of coating, moderation of stress in the protective layer, reduction in surface energy and reduction in friction coefficient. For the radical polymerizable monomers and the radical polymerizable oligomer, conventional ones can be used.

Examples of the monofunctional radical polymerizable monomer include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate and styrene monomers.

Examples of the difunctional radical polymerizable monomer include 1,3-butanediol diacrylate, 1,4-butanediol diacrylate, 1,4-butanediol dimethacrylate, 1,6-hexanediol diacrylate, 1,6-hexanediol dimethacrylate, diethyleneglycol diacrylate, neopentylglycol diacrylate, bisphenol A-EO-modified diacrylate, bisphenol F-EO-modified diacrylate and neopentylglycol diacrylate.

Examples of the functional monomer include fluorine-substituted monomers such as octafluoropentyl acrylate, 2-perfluorooctylethyl acrylate, 2-perfluorooctylethyl methacrylate and 2-perfluoroisononylethyl acrylate; the vinyl monomers, the acrylates and the methacrylates all having polysiloxane groups that are between 20 and 70 in siloxane repeating unit, such as acryloylpolydimethylsiloxaneethyl, methacryloylpolydimethylsiloxaneethyl, acryloylpolydimethylsiloxanepropyl, acryloylpolydimethylsiloxanebutyl and diacryloylpolydimethylsiloxanediethyl, described in Japanese Patent Application Publication (JP-B) Nos. 05-60503 and 06-45770.

Examples of the radical polymerizable oligomer include epoxy acrylate-based oligomers, urethane acrylate-based oligomers and polyester acrylate-based oligomers.

It should, however, be noted that inclusion of the monofunctional and difunctional radical polymerizable monomers and the radical polymerizable oligomer in large quantities causes the three-dimensional crosslinking bond density of the crosslinked-type charge transporting layer to lower substantially, thereby leading to a decrease in the abrasion resistance thereof. Therefore, the content of the monomers and the oligomer is limited to 50 parts by mass or less, preferably 30 parts by mass or less, in relation to 100 parts by mass of the trifunctional or more radical polymerizable monomer.

The protective layer of the present invention is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles; it should be noted that a polymerization initiator may be contained in a crosslinked-type charge transporting layer coating solution according to necessity so as to allow this curing reaction to progress efficiently.

Examples of a thermal polymerization initiator include peroxide-based initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butyl peroxide, t-butyl hydroperoxide, cumene hydroperoxide, lauroyl peroxide and 2,2-bis(4,4-di-t-butyl peroxy cyclohexy)propane; and azo-based initiators such as azobisisobutylnitrile, azobiscyclohexanecarbonitrile, methyl azobisisobutyrate, azobisisobutylamidine hydrochloride and 4,4′-azobis-4-cyanovaleric acid.

Examples of a photopolymerization initiator include acetophenone-based or ketal-based photopolymerization initiators such as diethoxyacetophenone, 2,2-dimethoxy-1,2-diphenylethane-1-on, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-on, 2-methyl-2-morpholino(4-methylthiophenyl)propane-1-on and 1-phenyl-1,2-propanedione-2-(o-ethoxycarbonyl)oxime; benzoin ether-based photopolymerization initiators such as benzoin, benzoin methyl ether, benzoin ethyl ether, benzoin isobutyl ether and benzoin isopropyl ether; benzophenone-based photopolymerization initiators such as benzophenone, 4-hydroxybenzophenone, methyl o-benzoylbenzoate, 2-benzoylnaphthalene, 4-benzoylbiphenyl, 4-benzoylphenyl ether, acrylated benzophenone and 1,4-benzoylbenzene; thioxanthone-based photopolymerization initiators such as 2-isopropylthioxanthone, 2-chlorothioxanthone, 2,4-dimethylthioxanthone, 2,4-diethylthioxanthone and 2,4-dichlorothioxanthone; and other photopolymerization initiators such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methylphenylglyoxyester, 9,10-phenanthrene, acridine-based compounds, triazine-based compounds and imidazole-based compounds. Also, compounds having photopolymerization promoting effects may be used independently or together with the photopolymerization initiators. Examples thereof include triethanolamine, methyldiethanolamine, ethyl 4-dimethylaminobenzoate, isoamyl 4-dimethylaminobenzoate, (2-dimethylamino)ethyl benzoate and 4,4′-dimethylamino benzophenone.

These polymerization initiators may be used in combination. The content of the polymerization initiator is 0.5 parts by mass to 40 parts by mass, preferably 1 part by mass to 20 parts by mass, in relation to 100 parts by mass of a total contained material having radical polymerizability.

Further, in the protective layer coating solution of the present invention, additives such as plasticizers (for the purpose of moderating stress, improving adhesion, etc.), a leveling agent and a low-molecular charge transporting material without radical reactivity can be contained according to necessity. Conventional additives can be used for these additives; for the plasticizers, ones used in ordinary resins, such as dibutyl phthalate and dioctyl phthalate, can be utilized, and the amount thereof used is reduced to 20% by mass or less, preferably 10% by mass or less, in relation to the total solid content of the coating solution. For the leveling agent, a silicone oil such as dimethyl silicone oil or methylphenyl silicone oil, a polymer or oligomer having a perfluoroalkyl group in its side chain, a mixture of an acrylic group-containing polyester-modified polydimethylsiloxane and a propoxy-modified-2-neopentylglycol diacrylate, or the like can be used, and it is appropriate that the amount thereof used be 3% by mass or less to the total solid content of the coating solution.

The protective layer of the present invention is formed by applying onto the charge transporting layer a coating solution containing at least a trifunctional or more radical polymerizable monomer having no charge transporting structure, a fluorine-based UV-curable hard coat agent, a monofunctional radical polymerizable compound having a charge transporting structure, and lubricant fine particles, and curing the coating solution. When the radical polymerizable monomer is a liquid, the coating solution can be applied with the other components dissolved in the radical polymerizable monomer; alternatively, the coating solution is diluted with a solvent and thus applied if necessary. Examples of the solvent used on this occasion include alcohols such as methanol, ethanol, propanol and butanol; ketones such as acetone, methyl ethyl ketone, methyl isobutyl ketone and cyclohexanone; esters such as ethyl acetate and butyl acetate; ethers such as tetrahydrofuran, dioxane and propyl ether; halogen-containing compounds such as dichloromethane, dichloroethane, trichloroethane and chlorobenzene; aromatic compounds such as benzene, toluene and xylene; and cellosolves such as methyl cellosolve, ethyl cellosolve and cellosolve acetate. These solvents may be used independently or in combination. The dilution rate at which the coating solution is diluted with the solvent varies according to the solubility of a composition, the coating method employed and the desired layer thickness, and can be arbitrarily decided. The coating solution can be applied by means of an immersion coating method, spray coating, beat coating, a ring coating method or the like.

In the present invention, the protective layer is formed by applying such a protective layer coating solution and then curing it with application of energy from outside; the external energy used on this occasion is selected from thermal energy, light energy and radiant energy. As to how the thermal energy is applied, the protective layer coating solution is heated from the coated surface side or the substrate side, using a gas such as air or nitrogen, vapor, any type of heating medium, an infrared ray or an electromagnetic wave. It is desirable that the heating temperature be in the range of 100° C. to 170° C.; when it is less than 100° C., the reaction velocity is low, and the curing reaction does not completely finish. When it is greater than 170° C., the curing reaction progresses unevenly, and great strain or a large number of unreacted residues and unreactive termini arise in the protective layer. To make the curing reaction progress evenly, there is an effective method in which after the protective layer coating solution is heated at a relatively low temperature of less than 100° C., it is heated at 100° C. or greater and the reaction is thus completed. For the light energy, a UV irradiation light source such as a high-pressure mercury-vapor lamp or metal halide lamp having an emission wavelength in the ultraviolet region is mainly used; it is also possible to opt for a visible light source according to the absorption wavelength of a radical polymerizable contained material or a photopolymerization initiator. It is desirable that the dose of light irradiation be in the range of 50 mW/cm² to 1,000 mW/cm²; when it is less than 50 mW/cm², the curing reaction takes a great deal of time. When it is greater than 1,000 mW/cm², the reaction progresses unevenly, and local creases arise on the protective layer surface, or a large number of unreacted residues and unreactive termini arise. Also, the abrupt crosslinkage makes internal stress greater, which is a cause of cracks and film peeling. Examples of the radiant energy include energy by means of electron rays. Amongst these forms of energy, thermal energy and light energy are useful in that the reaction velocity can be controlled with ease and an apparatus can be simplified, with particular preference being given to light energy.

It is desirable that the thickness of the protective layer of the present invention be in the range of 1 μm to 10 μm, more desirably in the range of 2 μm to 8 μm. When it is greater than 10 μm, cracks and film peeling are liable to arise as described above; whereas when it is 8 μm or less, the protective layer has a further improved safety margin, so that it becomes possible to increase the crosslink density and also it becomes possible to select a material and to set curing conditions for higher abrasion resistance. Meanwhile, radical polymerization reaction is easily hindered by oxygen; specifically, on a surface contiguous to the air, crosslinkage is liable to be prevented from progressing or to become uneven, affected by a radical trap which is due to oxygen. This negative effect becomes conspicuous when a surface layer is 1 μm or less in thickness, and a protective layer of this thickness or less is liable to decrease in abrasion resistance and to wear unevenly. Moreover, when the protective layer coating solution is applied, some components of the charge transporting layer placed below are mixed into the solution. When the coating film of the protective layer is thin, the mixed components spread throughout the protective layer, thereby hindering the curing reaction and decreasing the crosslink density. For these reasons, the protective layer of the present invention has favorable abrasion resistance and scratch resistance when it is 1 μm or more in thickness; however, when there is a portion where the protective layer is locally missing as far as the charge transporting layer below as it is peeled away through repetitive use, abrasion at this portion increases, and the density of halftone images is liable to become uneven owing to variations in charging properties and sensitivity. Therefore, to achieve a long lifetime and high image quality, it is desirable that the thickness of the protective layer be 2 μm or greater.

As to the diluent solvent for the protective layer coating solution, when a solvent low in evaporation rate is used, it is possible that a residual solvent may hinder curing and may increase the mixed amount of the under layer components, and uneven curing and a decrease in curing density may therefore be brought about. Thus, the protective layer coating solution tends to be soluble in organic solvent. Specifically, tetrahydrofuran, a mixed solvent of tetrahydrofuran and methanol, ethyl acetate, methyl ethyl ketone, ethyl cellosolve and the like are useful, with the best one being selected according to the coating method employed. As for the concentration of the solid content, when it is very low for a similar reason, the protective layer coating solution tends to be soluble in organic solvent. Due to restrictions on the layer thickness and the coating solution viscosity, there are limitations on the maximum concentration. Specifically, it is desirable that the concentration of the solid content be in the range of 10% by mass to 50% by mass. As the coating method for the protective layer, a method of reducing the content of the solvent when a coating film is formed and reducing the time during which the coating solution is in contact with the solvent is preferable for a similar reason; specifically, a spray coating method, and a ring coating method whereby the amount of coating solution is restricted are methods that make it easier to secure stability of quality in terms of production and are therefore suitable. Also, use of a high-molecular charge transporting material as a charge transporting layer and provision of an intermediate layer insoluble in a coating solvent for the crosslinked-type charge transporting layer are effective means for reducing the mixed amount of the under layer components.

As described in Paragraph No. [0014] of JP-A No. 06-95415, when the ratio of fluorine resin included is greater than 50% by mass, the transfer degree of photoinduced charge carriers decreases, thereby possibly leading to deterioration in sensitivity. Thus, it is reasonable to set the layer thickness such that the charge transfer degree of the protective layer does not become a rate-limiting factor in relation to the photoconductor sensitivity.

### EXAMPLES

Next, the present invention will be explained in further detail, referring to Examples; it should, however, be noted that the present invention is not confined to these Examples.

### Example 1

An under layer of 3.5 μm in thickness, a charge generating layer of 0.2 μm in thickness and a charge transporting layer of 19 μm in thickness were formed by applying an under layer coating solution, a charge generating layer coating solution and a charge transporting layer coating solution with the following proportions onto an aluminum drum of 0.8 mm in thickness, 340 mm in length and 30 mm in external diameter φ and drying the coating solutions, respectively. A protective layer coating solution with the following proportion was applied thereon by means of a spray, and then all these coating solutions underwent UV curing while the drum was being rotated, with the drum and a UV curing lamp apart from each other by 120 mm. The UV curing lamp illuminance with respect to this positioning was 600 mW/cm² (which is the value measured by an ultraviolet integrating actinometer UIT-150 produced by Ushio Inc.). The rotation speed of the drum was set at 25 rpm. When the UV curing was conducted, a rod-like metal block was enveloped in the aluminum drum. In the UV curing, 30 seconds of exposure and 120 seconds of interruption were repeated, and exposure was carried out for 7 minutes in total. After the UV curing, the coating solutions were heated and dried at 130° C. for 30 minutes. As a result, an electrophotographic photoconductor with a protective layer of 5 μm in thickness was obtained.

| | | |
|---|---|---|
| alkyd resin solution (BECKOLITE M6401-50 produced by Dainippon | 12 | parts by mass |
| Ink And Chemicals, Incorporated) | | |
| melamine resin solution (SUPER BECKAMINE G-821-60 produced | 8 | parts by mass |
| by Dainippon Ink And Chemicals, Incorporated) | | |
| titanium oxide (CR-EL produced by Ishihara Sangyo Kaisha, Ltd.) | 40 | parts by mass |
| methyl ethyl ketone | 200 | parts by mass |
| [Charge generating layer coating solution] | | |
| bisazo pigment with the following structure (produced by Ricoh | 5 | parts by mass |
| Company, Ltd.) | | |

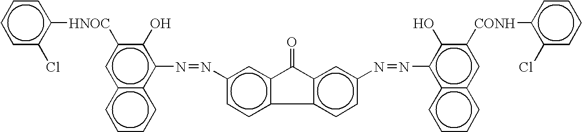

| | | |
|---|---|---|
| polyvinyl butyral (XYHL produced by Union Carbide Corporation) | 1 | part by mass |
| cyclohexanone | 200 | parts by mass |
| methyl ethyl ketone | 80 | parts by mass |
| [Charge transporting layer coating solution] | | |
| Z-type polycarbonate (PANLITE TS-2050 produced by Teijin | 10 | parts by mass |
| Chemicals Ltd.) | | |
| low-molecular charge transporting material with the following | 7 | parts by mass |
| structure | | |
| 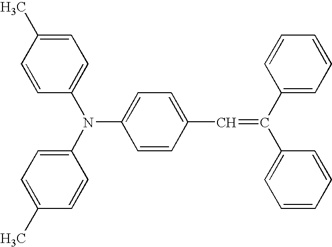 | | |
| tetrahydrofuran | 100 | parts by mass |
| 1% silicone oil (KF50-100CS produced by Shin-Etsu Chemical Co., | 1 | part by mass |
| Ltd.) tetrahydrofuran solution | | |
| [Protective layer coating solution] | | |
| monofunctional radical polymerizable compound having a charge | 50 | parts by mass |
| transporting structure, with the following structure | | |
| 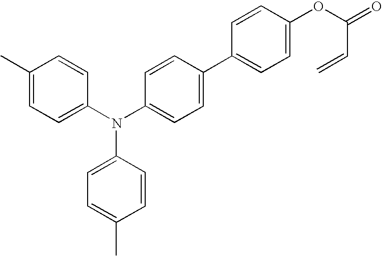 | | |
| trifunctional or more radical polymerizable monomer having no | 25 | parts by mass |
| charge transporting structure | | |
| trimethylolpropane triacrylate | | |
| (KAYARAD TMPTA produced by Nippon Kayaku Co., Ltd.) | | |
| trifunctional or more radical polymerizable monomer having no | 25 | parts by mass |
| charge transporting structure | | |
| dipentaerythritol caprolactone-modified hexaacrylate | | |
| (KAYARAD DPCA-120 produced by Nippon Kayaku Co., Ltd.) | | |
| molecular weight: 1,947, number of functional groups: 6, | 5 | parts by mass |
| molecular weight/number of functional groups = 325 | | |
| photopolymerization initiator | | |
| 1-hydroxycyclohexylphenylketone | | |
| (IRGACURE 184 produced by Ciba Specialty Chemicals) | | |
| leveling agent | 0.1 | parts by mass |
| mixture of acrylic group-containing polyester-modified | | |
| polydimethylsiloxane and propoxy-modified-2-neopentylglycol | | |
| diacrylate | | |
| (BYK-UV 3570 produced by BYK Additives & Instruments) | | |
| lubricant fine particles | 25.5 | parts by mass |
| copolymer of tetrafluoroethylene and perfluoroalkyl vinyl ether | | |
| (MPE-056 produced by Du Pont-Mitsui Fluorochemicals | | |
| Company, Ltd.) | | |
| fluorine-based hard coat agent | 16 | parts by mass |
| (CEFRAL COAT A101E produced by Central Glass Co., Ltd.) | | |
| (solid content: 60% by mass, OH value: 34 mg KOH/g) | | |
| isocyanate monomer (KARENZ AOI produced by Showa Denko K.K.) | 1 | part by mass |
| tetrahydrofuran | 836 | parts by mass |

### (Measuring Method)

### (1) Measurement of Leakage Intensity

A photoconductor set for measuring the leakage intensity incorporated the components of a photoconductor set of IMAGIO NEO C455 (i.e. a photoconductor, a cleaning brush, a cleaning blade, a charging roller cleaner, a lubricant (rod-like zinc stearate) and the like), excluding the cleaning brush, the charging roller cleaner and the rod-like zinc stearate. This photoconductor set was installed in a black development station. A DC bias included in a bias applied onto a charging roller of IMAGIO NEO C455 was adjusted so as to set the charge potential of the photoconductor at −700V. Subsequently, the amount of writing light was adjusted such that the potential of an exposed portion became −250V. With this state kept, solid patterns were written, making various alterations to a developing bias. A toner which had been input to the photoconductor before image transfer took place was collected with a transparent adhesive tape (PRINTAC C produced by Nitto Denko Corporation), the image density of the toner on the tape was measured by a reflection spectroscopic density meter (X-RITE 939 produced by Canon i-tech, Inc.), and such a developing bias as made this density become 1.0 was employed.

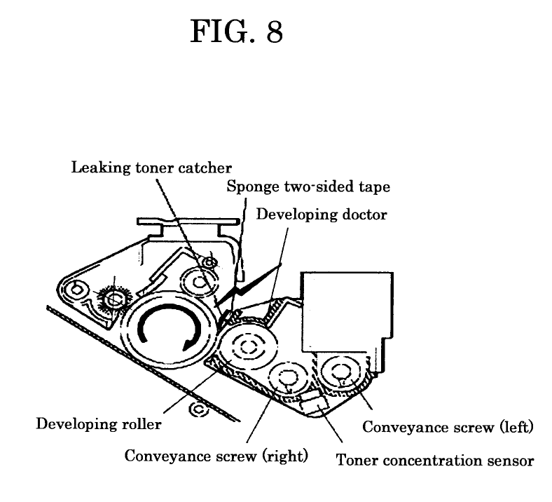

Next, a leaking toner catcher (8 mm×310 mm felt having a thickness of 1 mm (produced by Tsuchiya Co., Ltd.)) was stuck onto the upper end of an opening portion of a developing unit, with a linear sponge tape of 2 mm in thickness (SCOTCH TAPE 4016 produced by Sumitomo 3M Limited) being placed in between (see FIG. 8). These components were attached to a main body.

With installation of an unused cleaning blade made exclusively for IMAGIO NEO C455 and the photoconductor drum obtained in Example 1, a test pattern image with an image density of 5% for the A4 paper size was continuously printed on 50 sheets of copy paper (MY PAPER A4 produced by NBS Ricoh Co., Ltd.) at 23° C. and at an RH of 55%. For the toner, a polymerized toner made exclusively for the photoconductor set was used.

After the printing, the leaking toner catcher was removed, and an image formed thereon was transformed into digital data, using an image scanner (ES-8500 produced by Seiko Epson Corporation). The image data was read by the scanner under the following conditions. Zooming: 100%, color correction by a color driver: 1.0, output: 800 dpi, photograph: 800 dpi, unsharp mask: medium, and 8 bit gray.

On the basis of the image data, the density and area ratio of the image on the leaking toner catcher were calculated under the conditions of 210 in upper maximum value, 310 in lower maximum value and five divisions with respect to a pseudo-color command, using Image-Pro Plus ver. 3.0 produced by Media Cybernetics, Inc., and the sum of these was calculated as the leakage intensity.

The leakage intensity was calculated based upon the electrophotographic photoconductor at the start of the test and also calculated based upon the electrophotographic photoconductor after the following evaluation of images was carried out.

The leakage intensities calculated for all the Examples before and after the evaluation of images are shown in Table 1.

### (2) Evaluation of Images

The electrophotographic photoconductor of Example 1 produced as described above was made suitable for practical use and then installed in every development station of the image forming apparatus (IMAGIO NEO C455 produced by Ricoh Company, Ltd.), and a halftone pattern in which an 8×8 matrix was provided with 4 dots×4 dots at a pixel density of 600 dpi×600 dpi was printed out on a total of 200,000 sheets of copy paper (MY PAPER A4 produced by NBS Ricoh Co., Ltd.) under such a condition that the halftone pattern was continuously printed on five sheets at each time. Rod-like zinc stearate was removed from the whole photoconductor set.

A load spring provided on the cleaning blade was changed to a stainless steel spring of 0.68 N/mm in spring load, 14 mm in free length and 5 mm in internal diameter so that the leakage intensity became 25.

As for toners and developers, products made exclusively for IMAGIO NEO C455 were used.

For the photoconductor unit, a product made exclusively for IMAGIO NEO C455 was used. Regarding a voltage applied onto the charging roller, a peak-to-peak voltage of 1.5 kV and a frequency of 0.9 kHz were selected for its AC component. Meanwhile, such a bias as made the charge potential of the photoconductor at the start of the test become −700V was set for its DC component, and the test was conducted on this charging condition until the test finished. The developing bias was set at −500V. Note that in this apparatus, a charge-eliminating unit was not provided. The test was conducted, with the cleaning unit being replaced by an unused cleaning unit made exclusively for IMAGIO NEO C455, every time the number of printed sheets amounted to 50,000. After the test, color test charts were copied onto sheets of PPC paper TYPE-6200A3. The test was conducted at 23° C. and at an RH of 55%.

Copied images based upon the color test charts (COLOR CHART C-5 produced by Ricoh Company, Ltd.) were evaluated for background smear in blank spaces and classified into five grades. The results are shown in Table 1.

5: very superior

4: superior

3: acceptable

2: slightly dirty but acceptable in practical use

1: dirty.

### Example 2

A test was conducted in a manner similar to that of Example 1, except that the fluorine-based UV-curable hard coat agent contained in the protective layer coating solution in Example 1 was changed to the following compound. Also, as for a load spring of a cleaning blade, the same load spring as that of Example 1 was used. fluorine-based hard coat agent

(Cefral Coat A402B produced by Central Glass Co., Ltd.)

(solid content: 55% by mass, OH value: 25 mg KOH/g) 16 parts by mass.

### Example 3

A test was conducted in a manner similar to that of Example 1, except that the fluorine-based UV-curable hard coat agent contained in the protective layer coating solution in Example 1 was changed to the following compound, and that the proportions of the fluorine-based UV-curable hard coat agent, the lubricant fine particles and the tetrahydrofuran were changed to the following proportions. Also, as for a load spring of a cleaning blade, the same load spring as that of Example 1 was used.

| | |
|---|---|
| lubricant fine particles (MPE-056 produced by | 13.5 parts by mass |
| Du Pont-Mitsui Fluorochemicals Company, Ltd.) | |
| fluorine-based hard coat agent | 8 parts by mass |
| (Cefral Coat A610X produced by Central | |
| Glass Co., Ltd.) | |
| (solid content: 61% by mass, OH value: | |
| 48 mg KOH/g) | |
| isocyanate monomer (KARENZ AOI produced by | 1 part by mass |
| Showa Denko K.K.) | |
| tetrahydrofuran | 723 parts by mass |

### Example 4

A test was conducted in a manner similar to that of Example 1, except that the fluorine-based UV-curable hard coat agent contained in the protective layer coating solution in Example 1 was changed to the following compound, and that the proportions of the fluorine-based UV-curable hard coat agent, the lubricant fine particles, the isocyanate monomer and the tetrahydrofuran were changed to the following proportions. Also, as for a load spring of a cleaning blade, the same load spring as that of Example 1 was used.

| | |
|---|---|
| lubricant fine particles (MPE-056 produced by | 9 parts by mass |
| Du Pont-Mitsui Fluorochemicals Company, Ltd.) | |
| fluorine-based hard coat agent | 4 parts by mass |
| (MODIPER F200 produced by NOF | |
| CORPORATION) (solid content: 30% by mass) | |
| isocyanate monomer (KARENZ AOI produced by | 2 part by mass |
| Showa Denko K.K.) | |
| tetrahydrofuran | 681 parts by mass |

### Example 5

A test was conducted in a manner similar to that of Example 1, except that 25.5 parts by mass of the lubricant fine particles (MPE-056 produced by Du Pont-Mitsui Fluorochemicals Company, Ltd.) contained in the protective layer coating solution in Example 1 were changed to 25.5 parts by mass of a polyethylene wax (CERAFLOUR 991 produced by BYK-Cera).

### Example 6

A test was conducted in a manner similar to that of Example 1, except that 25.5 parts by mass of the lubricant fine particles (MPE-056 produced by Du Pont-Mitsui Fluorochemicals Company, Ltd.) contained in the protective layer coating solution in Example 1 were changed to 25.5 parts by mass of a silicone-acrylic copolymer (CHALINE R-170S produced by Nissin Chemical Industry Co., Ltd.).

### Example 7

A test was conducted in a manner similar to that of Example 1, except that in the protective layer coating solution in Example 1, the monofunctional radical polymerizable compound having a charge transporting structure was changed to the compound of the following structure and the proportions of the fluorine-based UV-curable hard coat agent, the isocyanate monomer and the tetrahydrofuran were changed to the following proportions. Also, as for a load spring of a cleaning blade, the same load spring as that of Example 1 was used.

| | |
|---|---|
| monofunctional radical polymerizable compound | 50 parts by mass |
| having a charge transporting structure, | |
| with the following structure | |
| lubricant fine particles (MPE-056 produced by | 3.2 parts by mass |
| Du Pont-Mitsui Fluorochemicals Company, Ltd.) | |
| fluorine-based hard coat agent | 2 parts by mass |
| (Cefral Coat A101E produced by Central | |
| Glass Co., Ltd.) | |
| (solid content: 60% by mass, OH value: | |
| 34 mg KOH/g) | |
| isocyanate monomer (KARENZ AOI produced by | 0.13 parts by mass |
| Showa Denko K.K.) | |
| tetrahydrofuran | 626 parts by mass |

### Example 8

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 95.7 parts by mass |
| Pont-Mitsui Fluorochemicals Company, Ltd.) | |
| fluorine-based hard coat agent | 60 parts by mass |
| (CEFRAL COAT A101E produced by Central | |
| Glass Co., Ltd.) (solid content: 60% by mass, | |
| OH value: 34 mg KOH/g) | |
| isocyanate monomer (KARENZ AOI produced by | 3.8 parts by mass |
| Showa Denko K.K.) | |
| tetrahydrofuran | 1,499 parts by mass |

### Example 9

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by | 10.2 parts by mass |
| Du Pont-Mitsui Fluorochemicals Company, Ltd.) | |
| fluorine-based hard coat agent | 22.4 parts by mass |
| (CEFRAL COAT A101E produced by Central | |
| Glass Co., Ltd.) (solid content: 60% by mass, | |
| OH value: 34 mg KOH/g) | |
| isocyanate monomer (KARENZ AOI produced by | 1.4 parts by mass |
| Showa Denko K.K.) | |
| tetrahydrofuran | 788 parts by mass |

### Example 10

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 23.8 parts by mass |
| Pont-Mitsui Fluorochemicals Company, Ltd.) | |
| fluorine-based hard coat agent | 9.6 parts by mass |
| (CEFRAL COAT A101E produced by Central | |
| Glass Co., Ltd.) (solid content: 60% by mass, | |
| OH value: 34 mg KOH/g) | |
| isocyanate monomer (KARENZ AOI produced by | 0.6 parts by mass |
| Showa Denko K.K.) | |
| tetrahydrofuran | 788 parts by mass |

### Example 11

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 13.6 parts by mass |
| Pont-Mitsui Fluorochemicals Company, Ltd.) | |
| fluorine-based hard coat agent | 3.2 parts by mass |
| (Cefral Coat A101E produced by Central Glass | |
| Co., Ltd.) (solid content: 55% by mass, OH | |
| value: 25 mg KOH/g) | |
| isocyanate monomer (KARENZ AOI produced by | 0.2 parts by mass |
| Showa Denko K.K.) | |
| tetrahydrofuran | 692 parts by mass |

### Example 12

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 7.7 parts by mass |
| Pont-Mitsui Fluorochemicals Company, Ltd.) | |
| fluorine-based hard coat agent | 28.8 parts by mass |
| (Cefral Coat A101E produced by Central Glass | |
| Co., Ltd.) (solid content: 55% by mass, OH | |
| value: 25 mg KOH/g) | |
| isocyanate monomer (KARENZ AOI produced by | 1.8 parts by mass |
| Showa Denko K.K.) | |
| tetrahydrofuran | 812 parts by mass |

### Example 13

A test was conducted in a manner similar to that of Example 2, except that the lubricant fine particles in Example 2 were changed to the following compound. Also, as for a load spring of a cleaning blade, the same load spring as that of Example 1 was used. polyethylene wax (CERAFLOUR 991 produced by BYK-Cera) 25.5 parts by mass.

### Example 14

A test was conducted in a manner similar to that of Example 3, except that the lubricant fine particles in Example 3 were changed to the following compound. Also, as for a load spring of a cleaning blade, the same load spring as that of Example 1 was used. polyethylene wax (CERAFLOUR 991 produced by BYK-Cera) 13.5 parts by mass.

### Example 15

A test was conducted in a manner similar to that of Example 4, except that the lubricant fine particles in Example 4 were changed to the following compound. Also, as for a load spring of a cleaning blade, the same load spring as that of Example 1 was used. polyethylene wax (CERAFLOUR 991 produced by BYK-Cera) 9 parts by mass.

### Example 16

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 31.9 parts by mass |
| Pont-Mitsui Fluorochemicals Company, Ltd.) | |
| fluorine-based hard coat agent | 120 parts by mass |
| (CEFRAL COAT A101E produced by Central Glass | |
| Co., Ltd.) (solid content: 60% by mass, | |
| OH value: 34 mg KOH/g) | |
| isocyanate monomer (KARENZ AOI produced by | 7.5 parts by mass |
| Showa Denko K.K.) | |
| tetrahydrofuran | 1499 parts by mass |

### Example 17

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 127.5 parts by mass |
| Pont-Mitsui Fluorochemicals Company, Ltd.) | |
| fluorine-based hard coat agent | 30 parts by mass |
| (CEFRAL COAT A101E produced by Central Glass | |
| Co., Ltd.) (solid content: 60% by mass, OH | |
| value: 34 mg KOH/g) | |
| isocyanate monomer (KARENZ AOI produced by | 1.9 parts by mass |
| Showa Denko K.K) | |
| tetrahydrofuran | 1499 parts by mass |

### Example 18

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | |
|---|---|
| lubricant fine particles (MPE-056 produced by Du | 1.1 parts by mass |
| Pont-Mitsui Fluorochemicals Company, Ltd.) | |
| fluorine-based hard coat agent | 4 parts by mass |
| (CEFRAL COAT A101E produced by Central Glass | |
| Co., Ltd.) (solid content: 60% by mass, OH | |
| value: 34 mg KOH/g) | |
| isocyanate monomer (KARENZ AOI produced by | 0.2 parts by mass |
| Showa Denko K.K.) | |
| tetrahydrofuran | 626 parts by mass |

### Example 19

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | | |
|---|---|---|
| lubricant fine particles (MPE-056 produced by Du | 4.3 | parts by mass |
| Pont-Mitsui Fluorochemicals Company, Ltd.) | | |
| fluorine-based hard coat agent | 1 | part by mass |
| (CEFRAL COAT A101E produced by Central | | |
| Glass Co., Ltd.) (solid content: 60% by mass, OH | | |
| value: 34 mg KOH/g) | | |
| isocyanate monomer (KARENZ AOI produced by | 0.06 | parts by mass |
| Showa Denko K.K.) | | |
| tetrahydrofuran | 626 | parts by mass |

### Example 20

A test was conducted in a manner similar to that of Example 7, except that the proportions of the fluorine-based UV-curable hard coat agent, the lubricant fine particles, the isocyanate monomer and the tetrahydrofuran contained in the protective layer coating solution in Example 7 were changed to the following proportions. Also, as for a load spring of a cleaning blade, the same load spring as that of Example 1 was used.

| | | |
|---|---|---|
| lubricant fine particles (MPE-056 produced by Du | 25.5 | parts by mass |
| Pont-Mitsui Fluorochemicals Company, Ltd.) | | |
| fluorine-based hard coat agent | 16 | parts by mass |
| (CEFRAL COAT A101E produced by Central | | |
| Glass Co., Ltd.) (solid content: 60% by mass, | | |
| OH value: 34 mg KOH/g) | | |
| isocyanate monomer (KARENZ AOI produced by | 1 | part by mass |
| Showa Denko K.K.) | | |
| tetrahydrofuran | 836 | parts by mass |

### Comparative Example 1

A test was conducted in a manner similar to that of Example 1, except that the proportions of the fluorine-based UV-curable hard coat agent, the lubricant fine particles and the isocyanate monomer contained in the protective layer coating solution in Example 1 were changed to the following proportions. Also, as for a load spring of a cleaning blade, the same load spring as that of Example 1 was used.

| | | |
|---|---|---|
| lubricant fine particles (MPE-056 produced by Du | 25.5 | parts by mass |
| Pont-Mitsui Fluorochemicals Company, Ltd.) | | |
| fluorine-based hard coat agent | 17 | parts by mass |
| (DEFENSER Exp. TF-3026 produced by | | |
| Dainippon Ink And Chemicals, Incorporated) | | |
| (solid content: 55% by mass) | | |
| isocyanate monomer (KARENZ AOI produced by | 0 | part by mass |
| Showa Denko K.K.) | | |

### Comparative Example 2

A test was conducted in a manner similar to that of Example 1, except that the proportions of the fluorine-based UV-curable hard coat agent, the lubricant fine particles and the isocyanate monomer contained in the protective layer coating solution in Example 1 were changed to the following proportions. Also, as for a load spring of a cleaning blade, the same load spring as that of Example 1 was used.

| | | |
|---|---|---|
| lubricant fine particles (MPE-056 produced by Du | 42.5 | parts by mass |
| Pont-Mitsui Fluorochemicals Company, Ltd.) | | |
| fluorine-based hard coat agent | 0 | part by mass |
| (CEFRAL COAT A101E produced by Central | | |
| Glass Co., Ltd.) (solid content: 60% by mass, | | |
| OH value: 34 mg KOH/g) | | |
| isocyanate monomer (KARENZ AOI produced by | 0 | part by mass |
| Showa Denko K.K.) | | |

### Comparative Example 3

A test was conducted in a manner similar to that of Example 1, except that the proportions of the fluorine-based UV-curable hard coat agent, the lubricant fine particles and the isocyanate monomer contained in the protective layer coating solution in Example 1 were changed to the following proportions. Also, as for a load spring of a cleaning blade, the same load spring as that of Example 1 was used.

| | | |
|---|---|---|
| lubricant fine particles (MPE-056 produced by Du | 0 | part by mass |
| Pont-Mitsui Fluorochemicals Company, Ltd.) | | |
| fluorine-based hard coat agent | 40 | parts by mass |
| (CEFRAL COAT A101E produced by Central | | |
| Glass Co., Ltd.) (solid content: 60% by mass, | | |
| OH value: 34 mg KOH/g) | | |
| isocyanate monomer (KARENZ AOI produced by | 2.5 | parts by mass |
| Showa Denko K.K.) | | |

### Comparative Example 4

A test was conducted in a manner similar to that of Example 1, except that the charge transporting material contained in the protective layer coating solution in Example 1 was changed to the following compound. Also, as for a load spring of a cleaning blade, the same load spring as that of Example 1 was used.

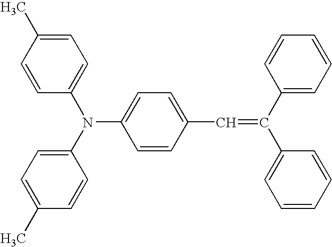

### Comparative Example 5

A test was conducted in a manner similar to that of Example 1, except that the charge transporting material contained in the protective layer coating solution in Example 1 was changed to the following compound.

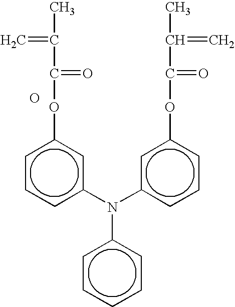

The image evaluation results thus obtained according to Examples 1 to 20 and Comparative Examples 1 to 5 are shown together with the leakage intensities in Table 1. Note that regarding the leakage intensity, the smaller it is, the better it is. Regarding the rank of image evaluation, the greater it is, the better it is.

TABLE 1-1

| | | Leakage intensity | Rank of image |
|---|---|---|---|
| | Initial leakage | after output | after output of |
| | intensity | of 200,000 sheets | 200,000 sheets |
| Example 1 | 30 | 95 | 4 |
| Example 2 | 45 | 90 | 4 |
| Example 3 | 40 | 95 | 4 |
| Example 4 | 30 | 100 | 4 |
| Example 5 | 35 | 80 | 4 |
| Example 6 | 40 | 90 | 4 |
| Example 7 | 55 | 130 | 3 |
| Example 8 | 50 | 135 | 3 |
| Example 9 | 60 | 125 | 3 |
| Example 10 | 55 | 120 | 3 |
| Example 11 | 70 | 120 | 3 |
| Example 12 | 55 | 120 | 3 |
| Example 13 | 45 | 90 | 4 |
| Example 14 | 40 | 95 | 4 |
| Example 15 | 45 | 95 | 4 |
| Example 16 | 50 | 130 | 2 |
| Example 17 | 55 | 135 | 2 |
| Example 18 | 60 | 140 | 2 |
| Example 19 | 60 | 135 | 2 |

TABLE 1-2

| | | Leakage intensity | Rank of image after |
|---|---|---|---|
| | Initial leakage | after output | output of |
| | intensity | of 200,000 sheets | 200,000 sheets |
| Example 20 | 50 | 115 | 3 |
| Comparative | 95 | 185 | 1 |
| Example 1 | | | |
| Comparative | 95 | 190 | 1 |
| Example 2 | | | |
| Comparative | 100 | 185 | 1 |
| Example 3 | | | |
| Comparative | 85 | 200 | 1 |
| Example 4 | | | |
| Comparative | 60 | 180 | 1 |
| Example 5 | | | |

As the lubricant fine particles and the fluorine-based UV-curable hard coat agent having a urethane bond in its molecule are included in the photoconductor protective layer with an appropriate amount ratio, it becomes possible to lower the friction coefficient of the photoconductor surface and thus to obtain favorable images that are superior in cleaning capability.

What is claimed is:

1. An electrophotographic photoconductor comprising:
a photoconductor substrate,
a photosensitive layer over the photoconductor substrate, and
a protective layer over the photoconductor substrate,
wherein the protective layer is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles.

2. The electrophotographic photoconductor according to claim 1, wherein the lubricant fine particles contain at least one selected from fluorine resin fine particles, a silicone compound and polyethylene wax.

3. The electrophotographic photoconductor according to claim 1, wherein the fluorine-based UV-curable hard coat agent has a urethane bond in its molecule.

4. The electrophotographic photoconductor according to claim 1, wherein the content of the fluorine-based UV-curable hard coat agent and the lubricant fine particles in the protective layer is equal to or greater than 5% by mass and less than 60% by mass with respect to the total weight of the protective layer, and the fluorine-based UV-curable hard coat agent and the lubricant fine particles are mixed together with a mass ratio of 3:7 to 7:3.

5. The electrophotographic photoconductor according to claim 1, wherein the monofunctional radical polymerizable compound having a charge transporting structure is represented by the following structural formula. 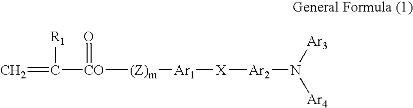
where R₁ denotes a hydrogen atom, a halogen atom, an alkyl group that may have a substituent, an aralkyl group that may have a substituent, an aryl group that may have a substituent, a cyano group, a nitro group, an alkoxy group, a —COOR₇ group (R₇ denotes a hydrogen atom, an alkyl group that may have a substituent, an aralkyl group that may have a substituent, or an aryl group that may have a substituent), a carbonyl halide group or a —CONR₈R₉ group (R₈ and R₉ each denote a hydrogen atom, a halogen atom, an alkyl group that may have a substituent, an aralkyl group that may have a substituent, or an aryl group that may have a substituent, and they may be identical or different from each other); Ar₁ and Ar₂ each denote a substituted or unsubstituted arylene group, and they may be identical or different from each other; Ar₃ and Ar₄ each denote a substituted or unsubstituted aryl group, and they may be identical or different from each other; X denotes a single bond, a substituted or unsubstituted alkylene group, a substituted or unsubstituted cycloalkylene group, a substituted or unsubstituted alkylene ether group, an oxygen atom, a sulfur atom or a vinylene group; Z denotes a substituted or unsubstituted alkylene group, a substituted or unsubstituted alkylene ether divalent group, or an alkyleneoxycarbonyl divalent group; and “m” denotes an integer of 0 to 3.

6. The electrophotographic photoconductor according to claim 1, wherein the components of the protective layer are cured by any one of heating and irradiation with light energy.

7. A process cartridge for an image forming apparatus, comprising:
an electrophotographic photoconductor, and
at least one selected from the group consisting of a charging unit, a developing unit, a transfer unit, a cleaning unit and a charge-eliminating unit,
wherein the electrophotographic photoconductor includes a photoconductor substrate, a photosensitive layer over the photoconductor substrate, and a protective layer over the photoconductor substrate; and the protective layer is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles, and wherein the process cartridge is detachably mountable to an image forming apparatus main body.

8. An image forming apparatus comprising:
any one of an electrophotographic photoconductor, and
a process cartridge,
wherein the electrophotographic photoconductor includes a photoconductor substrate, a photosensitive layer over the photoconductor substrate, and a protective layer over the photoconductor substrate; the protective layer is formed by curing together at least a trifunctional or more radical polymerizable monomer having no charge transporting structure, a fluorine-based UV-curable hard coat agent and a monofunctional radical polymerizable compound having a charge transporting structure, and contains lubricant fine particles; and the process cartridge includes the electrophotographic photoconductor, and one or more selected from the group consisting of a charging unit, a developing unit, a transfer unit, a cleaning unit and a charge-eliminating unit.
